(19) United States
(12) Patent Application Publication
(10) Pub. No.: US 2025/0182054 A1
(43) Pub. Date: Jun. 5, 2025

(54) INFRASTRUCTURE FOR ON-LINE COLLABORATION AND ELECTRONIC SUBMISSION EVALUATION

(71) Applicant: Lyssin LLC, Lake Grove, OR (US)

(72) Inventors: Joshua D. Frantz, Lake Oswego, OR (US); John H. Runne, Bainbridge Island, WA (US)

(21) Appl. No.: 18/528,277

(22) Filed: Dec. 4, 2023

(51) Int. Cl. G06Q 10/10

(52) U.S. Cl. CPC G06Q 10/103

(57) ABSTRACT

Briefly, example methods, apparatuses, and/or articles of manufacture are disclosed that may be implemented, in whole or in part, using one or more computing devices to facilitate and/or support one or more operations and/or techniques for an infrastructure for on-line collaboration and electronic submission evaluation, such as implemented in connection with one or more computing and/or communication networks and/or protocols.

### BACKGROUND

### Field

The present disclosure relates generally to computer and/or electronic infrastructures and, more particularly, to infrastructure for on-line collaboration and electronic submission evaluation.

### INFORMATION

On-line collaboration infrastructures, including electronic submission evaluation systems, for example, may enable users of computing devices to collaborate on-line, such as generate and/or electronically communicate digital content to various on-line recipients. For example, employee experience reporting system may enable employees to report comments, ideas, concerns, and the like to management. As another example, customer satisfaction reporting systems may enable customers of products or services to provide the producers and/or providers with comments regarding their experience, satisfaction, concerns, requests, or the like. These or like infrastructures may be implemented and/or deployed in various organizations utilizing on-line collaboration or like systems, such as learning institutions, interest clubs, political parties, industry organizations, special interest groups, for- or non-profit organizations, federal and/or local governments, or the like.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating features of an example operating environment for infrastructure for on-line collaboration and electronic submission evaluation, according to an implementation.

FIG. 2 is a flow diagram illustrating an implementation of an example process that may be performed, in whole or in part, to facilitate and/or support one or more operations and/or techniques for infrastructure for on-line collaboration and electronic submission evaluation.

FIG. 3 is a flow diagram illustrating an implementation of an example process that may be performed, in whole or in part, to facilitate and/or support one or more operations and/or techniques for infrastructure for on-line collaboration and electronic submission evaluation.

FIG. 4 is a flow diagram illustrating an implementation of an example process that may be performed, in whole or in part, to facilitate and/or support one or more operations and/or techniques for infrastructure for on-line collaboration and electronic submission evaluation.

FIG. 5 is a flow diagram illustrating an implementation of an example process that may be performed, in whole or in part, to facilitate and/or support one or more operations and/or techniques for infrastructure for on-line collaboration and electronic submission evaluation.

FIG. 6 is a diagram illustrated features of an example system that may, in whole or in part, facilitate and/or support one or more operations and/or techniques for infrastructure for on-line collaboration and electronic submission evaluation, according to an implementation.

FIG. 7 is a schematic diagram illustrating an example system embodiment of a network-connected device providing aspects of infrastructure for on-line collaboration and electronic submission evaluation, according to an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTIONS

References throughout this specification to one implementation, an implementation, one embodiment, an embodiment, and/or the like means that a particular feature, structure, characteristic, and/or the like described in relation to a particular example, implementation and/or embodiment is included in at least one example, implementation and/or embodiment of claimed subject matter. Thus, appearances of such phrases, for example, in various places throughout this specification are not necessarily intended to refer to the same implementation and/or embodiment and/or to any one particular implementation and/or embodiment. Furthermore, it is to be understood that particular features, structures, characteristics, and/or the like described are capable of being combined in various ways in one or more implementations and/or embodiments and, therefore, are within intended claim scope. Unless explicitly indicated to the contrary, reference to “another example” and/or “a further example” does not indicate that the described example is an exclusive alternative to a preceding example. In general, such examples may be alternatives to and/or additions to previous examples. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

Some example methods, apparatuses, and/or articles of manufacture are disclosed herein that may be used, in whole or in part, to facilitate and/or support one or more operations and/or techniques for infrastructure for on-line collaboration and electronic digital content evaluation. As will be seen, depending on an implementation, particular examples may include one or more computing and/or communications platforms for generating and/or communicating digital content, which may include electronic reporting and/or ideation submissions, such as without revealing an identity of an on-line user, for example, automated processing of such digital content, for digital content management infrastructure, or the like.

Typically, on-line collaboration infrastructures may be prone to a number of technical challenges. For example, one or more of these or like challenges may include selection and/or presentation of digital content of a particular interest, such as more desired, valid, and/or important electronic submissions from a larger number of received submissions. As another example, one or more of these or like challenges may also include technical issues with respect to providing and/or maintaining anonymity to on-line submitters while ensuring validity, usability, relevancy, suitability, applicability, etc. of such digital content. For example, in the context of a network computing system for an enterprise collaboration infrastructure, u validity, relevancy, suitability, applicability, etc. of an enterprise on-line collaboration system may be hampered by an employee user's fear of reprisal for reporting an issue within the enterprise. However, from the perspective of a recipient, validity, usability, relevancy, suitability, applicability, etc. of a collaboration system may be negatively impacted by receiving unverified, unusable, invalid, irrelevant, or like electronic submissions. Thus, one or more implementations of a technological infrastructure described herein may facilitate and/or support more effective and/or more efficient operations and/or processes for validity, usability, relevancy, suitability, applicability, etc. of on-line collaboration infrastructures by providing submission anonymity and submission validation and/or evaluation.

As discussed further below, in some instances, these or like approaches may provide improvements in computing devices and/or computing processes, such as for reporting technology, for example, by facilitating interaction between a variety of digital systems, by improving usability of on-line collaboration infrastructures, by increasing the dissemination of reporting submissions, by improving validity, usability, relevancy, suitability, applicability, and/or the like.

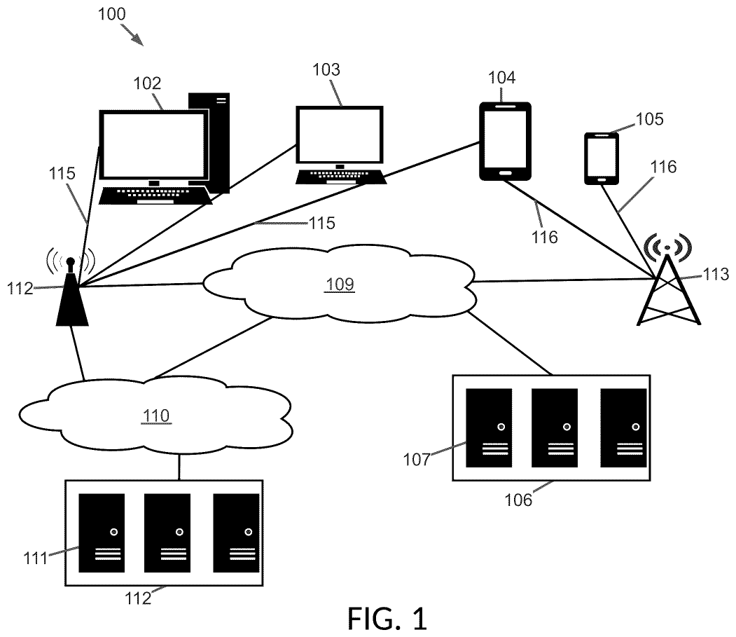

FIG. 1 is a schematic diagram illustrating features associated with an implementation of an example operating environment 100 capable of facilitating and/or supporting one or more platforms and/or techniques for infrastructure for on-line collaboration and electronic submission evaluation. It should be appreciated that operating environment 100 is described herein as a non-limiting example that may be implemented, in whole or in part, in the context of various wired and/or wireless communications networks, and/or any suitable portion and/or combination of such networks. For example, these or like networks may include one or more public networks (e.g., the Internet, the World Wide Web), private networks (e.g., intranets), wireless wide area networks (WWAN), wireless local area networks (WLAN, etc.), wireless personal area networks (WPAN), telephone networks, cable television networks, Internet access networks, fiber-optic communication networks, waveguide communication networks, or the like. It should also be noted that claimed subject matter is not limited to a particular network and/or operating environment.

The example environment 100 includes a plurality of user devices 102, 103, 104, 105, including a personal computer (PC) 102, laptop computer 103, tablet device 104, and smartphone 105. Other user devices may include personal digital assistants (PDAs), personal audio and/or video devices, or the like. Additionally, such user devices may be virtualized devices residing on another computing infrastructure, such as a data center comprising a plurality of servers. These devices are connected to various Internet Protocol (IP)-type infrastructures, including a public network 109, such as the Internet, and/or a private network 110 such as a workplace intranet. Such connections may include local connections 115 to an access point 112 that provides a routed connection to the Internet 109 and/or the intranet 110. For example, wireless connections 115 may be implemented according to one of the 802.11 wireless networking protocols. Other such connections may include cellular network connections 116 that provide a routed connection to the Internet 109 via a telecommunications infrastructure 113 and to the intranet 110 via the Internet 109. For example, cellular communications connections 116 may be implemented according to the 5G and/or 4G telecommunications protocols. In some such environments 100, access to the intranet 110 may be provided via a direct network connection and/or via an intermediary network such as the Internet 109.

In this example, the user devices are connected via the Internet 109 to one or more Internet hosted services 106 and are connected via the private network 110 to one or more private hosted services 112. For example, services 106, 112 may be hosted on one or more servers 107, 111 located in one or more data centers. Such services may include a variety of discrete services provided by one or more software application components. Such components may communicate with each other and with the user devices according to various protocols, such as web-service technologies (e.g., HTML, asynchronous Javascript and XML (AJAX), and application programming interfaces (APIs) (e.g., JavaScript Object Notation (JSON) based RESTful interfaces). For example, servers 107 may comprise one or more e-mail servers, authentication servers, transaction servers, update servers, back-end servers, management servers, database servers, network-related servers, or the like.

Even though a certain number of computing platforms and/or devices are illustrated herein, any number of suitable computing platforms and/or devices may be implemented to facilitate and/or support one or more techniques and/or processes associated with operating environment 100. Again, these are merely example implementations, and claimed subject matter is not limited in this regard.

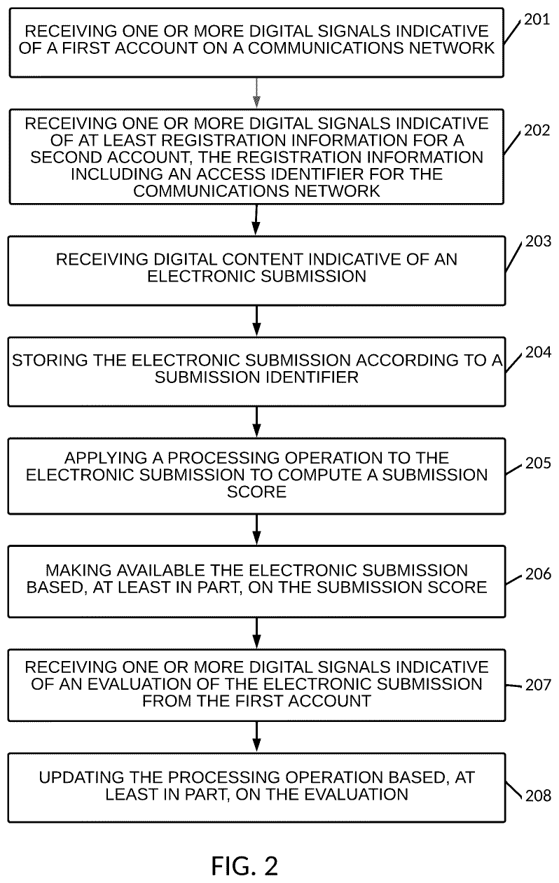

Attention is now drawn to FIG. 2, which is a flow diagram illustrating an implementation of an example process that may be performed, in whole or in part, to facilitate and/or support one or more operations and/or techniques for infrastructure for on-line collaboration and electronic submission evaluation. Even though one or more operations are illustrated and/or described concurrently and/or with respect to a certain sequence, other sequences and/or concurrent operations may be employed. In addition, although the description below references particular aspects and/or features illustrated in certain other figures, one or more operations may be performed with other aspects and/or features.

The example process may begin, for example, at operation 201 with receiving one or more digital signals indicative of a first account. The first account may be a recipient account to which subsequent electronic submissions will be directed. For instance, for an enterprise reporting system, the first account may be assigned to and/or otherwise associated with an executive officer, such as a chief executive officer (CEO) or department head, a member of a board of directors, an administrative assistant to one of the foregoing, or the like. In some implementations, the on-line collaboration infrastructure may include a built-in messaging system. In these implementations, the first account may be an account on the on-line collaboration infrastructure designated to receive incoming electronic submissions. In other implementations, the on-line collaboration infrastructure may interface with an external messaging system, such as an e-mail system or the like. In these implementations, the first account may be a designated account on and/or associated with such an external messaging system. In various implementations, the first account may be a controlling account, such as an owner account, administrator account, or the like, or the first account may be an account designated by such a controlling account.

In some examples, operation 201 may include receiving one or more digital signals indicative of a plurality of accounts. For example, the plurality of accounts may include a primary account and one or more subsidiary accounts. As discussed below, in these examples, the primary account may forward a submission to one or more of the subsidiary accounts and/or submissions may be automatically transmitted to one or more of the subsidiary accounts. In some instances, operation 201 may further include receiving signals indicative of categorical assignments for the subsidiary account. For example, categories of submissions may be selectively or automatically sent to corresponding subsidiary accounts. Such categories may be defined, based, at least in part, on expected and/or desired submission types, by the first account holder, a system owner or administrator, or the like. As a specific example in an enterprise setting, strategy-related submissions may be associated with a subsidiary account related to business development, market research or the like; process-related submissions may be associated with a subsidiary account related to business operations such as a chief-of-operations account, or the like; product-related submissions may be associated with a subsidiary account related to customer experience, marketing, product research, or the like; engineering-related submissions may be associated with a subsidiary account related to product development, technological research and development, product engineering, or the like; culture-related submissions may be associated with a subsidiary account related to human resources, or the like.

For instance, operation 201 may include receiving signals via a touch-sensitive screen, a computer mouse, a keyboard, and/or a voice-controlled interface. As another example, operation 201 may include receiving information input via a web form, user interface (UI), or other like. As a further example, operation 201 may include receiving signals input in these manners via one or more intermediary devices. As an example in the environment of FIG. 1, operation 201 may be performed by a user device 102, 103, 104, 105 receiving signals via an application, web-form, or the like; and/or operation 201 may be performed by a server 107, 111 receiving signals from a user device 102, 103, 104 via network 109, 110. In some examples, operation 201 might include receiving signals indicative of a user providing various account information for one or more designated accounts and/or one or more subsidiary accounts. For example, operation 201 might include receiving signals indicative of one or more e-mail addresses associated with the accounts and/or registration information associated with the accounts. Further examples of receiving digital signals indicative of a particular input should be understood as example implementations of operation 201. Further examples of operation 201 are discussed below.

The example process may include, for example, operation 202, which includes receiving one or more digital signals indicative of registration information for a second account. As illustrated, the registration information may include an access identifier for the first account. In various implementations, the access identifier may be a code, such as an alphanumeric code, one or more URL parameters, a particular registration URL, or the like. For example, the access identifier may be a code for the deployed instance of the reporting system corresponding to the first account discussed with respect to operation 201. In some instances, the access identifier may be disseminated to a target user group prior to registration. For example, an enterprise might provide an access identifier to the enterprise's instance of the on-line collaboration infrastructure to its employees via an email.

For instance, operation 202 may include receiving signals via a touch-sensitive screen, a computer mouse, a keyboard, and/or a voice-controlled interface. For example, operation 202 may include receiving information input via a web form, user interface (UI), or other like. In this example, operation 202 might include receiving signals indicative of a user providing various account information for a second account. For example, in addition to the access identifier, operation 202 might include receiving signals indicative of one or more e-mail addresses to be associated with the second account and/or other registration information for the second account. Further examples of receiving digital signals indicative of a particular input should be understood as example implementations of operation 202.

The example process may include, for example, operation 203, which includes receiving one or more digital signals indicative of a submission from the submitter account. For example, the submission may be a suggestion, an idea description, an observation, a constructive comment, a whistle blower narrative, or other like report. In some examples, the submission may include additional information elements, such as a submission category, a submission type, a summary, and/or an indicator that the submission should or should not be treated as an anonymous submission.

For instance, operation 203 may include receiving signals via a touch-sensitive screen, a computer mouse, a keyboard, and/or a voice-controlled interface. For example, operation 203 may include receiving information input via a web form, user interface (UI), or other like. In this example, operation 203 might include receiving signals indicative of a user filling out various fields of a predetermined digital submission form. For example, a electronic submission may include one or more categorical identifiers, such as the categories discussed above with respect to operation 201, submission type identifiers (e.g., whether the submission is an idea, an observation, a suggestion, a constructive comment, or the like), or the like. The submission may include one or more narrative or survey-type fields, such as a summary field, a detailed description field, one or more fields responding to customized prompts or questions, a field identifying a prior submission, or the like. The electronic submission may include one or more process-related fields, such as fields indicating whether or not the submission should be treated as an anonymous submission, whether the user is receptive to submission responses, to which recipient account the submission should be directed, or the like. Further examples of receiving digital signals indicative of a particular input should be understood as example implementations of operation 203. Further examples of operation 203 are discussed below.

The example process may include, for example, operation 204, which includes storing the electronic submission from operation 203 based, at least in part, on a submission identifier. For example, the submission identifier may be a number or alphanumeric information element that is unique to the particular submission which it identifies. In some instances, operation 204 may include computing the submission identifier in a manner that is independent of the particular account that provided the submission. For example, the submission identifier might be a serial number (e.g., a number computed based on the order the particular submission was received compared to other submissions), a timestamp-based number, a random/pseudo-random value, concatenation of multiple tags (such as a category identifier followed by a serial number or other like value), a hash of one of the submission fields or more of the foregoing numbers/values, or the like.

For instance, operation 204 may comprise storing the electronic submission or a link to the submission with the submission identifier. For example, the submission may be stored with the submission identifier via a variety of data storage systems, including: database systems such as relational databases, key-value stores, object databases, graph databases, object-relational databases, document-oriented databases, and the like; unstructured data storage systems such as object-based storage, file-based storage, content-addressable storage; combinations thereof, or other like storage systems.

In some instances, operation 204 may comprise storing the submission with the submission identifier in a manner such that the identity of the account holder that provided the submission is not available to the first account. For instance, operation 204 may be performed in this manner if operation 203 includes receiving an indicator that the submission should be treated as anonymous. For example, operation 204 may include storing the submission and the submission identifier in a first storage system and storing a mapping between the submission identifier and the second account in a second storage system. As another example, operation 204 may include storing the second account identity with the submission and submission identifier but providing different access rights to the items. For example, the submission and submission identifier may be stored at a first privilege level accessible to the first account and the second account identity may be stored at a second privilege level inaccessible to the first account. As a further example, operation 204 may include associating the submission with the access identifier used by the submitter account. For instance, this might be performed in examples having unique access identifiers for each submitter account. Further examples of storing data should be understood as example implementations of operation 204.

The example process may include, for example, operation 205, which includes applying a processing operation to the submission to compute a submission score. As an example in the environment of FIG. 1, operation 205 may include one or more servers 107, 111 executing software code applying the processing operation to the submission to compute the submission score. The submission score may be provided in various forms, such as numerical/point-based scores, positional rank, grades, or the like. The score may be based on various factors, such as a submission category, a submission type, usage of certain keywords, submission sentiment and/or semantic analyses, submission and/or sentence word counts, the presence and/or absence of certain fields, readability evaluations, specificity evaluations, other like factors, and/or combinations thereof. Various processing operations may be performed to determine the score. For example, the processing operations may include direct or scaling point assignment operations, statistical classification operations, natural language processing operations, supervised learning operations such as a random forest or other decision tree based scoring operations, unsupervised learning operations such as attention-based recurrent neural network operations, ensembles and/or other combinations thereof, and/or the like.

In some instances, operation 205 may include further processing operations, such as submission analysis operations. For example, operation 205 may include submission validation operations, which may include determining whether invalidating conditions are present in the submission. Examples of such invalidating conditions may include the presence of a hyperlink or other external reference, the presence of invalidating trigger words or phrases (such as violence-related terms or phrases, junk/fraud-related terms or phrases, or the like), a duplicate submission, other recipient-defined invalidating conditions, or the like. As another example, operation 205 may include performing similarity analyses with respect to prior submissions to determine whether the submission is a likely duplicate submission. Further examples of operation 205 are discussed below.

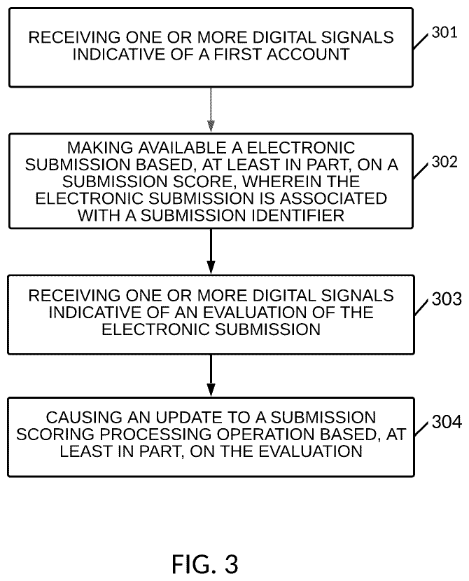

The example process may include, for example, operation 206, which includes making available the electronic submission based, at least in part, on the submission score. For example, operation 206 might include making the submission available for use by a mobile application, web browser, and/or web-based service to present the submission to the first account. The submission may be made available according to the submission score in various manners. For example, operation 206 may include presenting the submission as an element in a list of submissions ordered by submission scores. As another example, operation 206 may include presenting the submission with highlighting or other attention-drawing formatting applied to portions of the submission that most contributed to the submission score. As a further example, operation 206 may include making the submission available for a certain time based on the submission score. As a further example, operation 206 may include grouping the submission with other submissions according to the associated score and presenting group-level information (e.g., a word-cloud, summary table, or the like) to the first account. These and other examples of operation 206 are discussed further below with respect to FIGS. 3, 5, and 6.

The example process may include, for example, operation 207, which includes receiving one or more digital signals indicative of an evaluation of the submission. In some instances, the evaluation of the submission may be received from the first account holder, a subsidiary account holder, or another submitting account holder. In various implementations, the evaluation may comprise various formats and/or data. For example, the evaluation may comprise a value from an evaluation scale with one end of the scale being a highest evaluation rating and the other end being a lowest evaluation rating, such as a numerical scale (e.g., a 1-5 or 1-10 scale), a star rating scale, or the like. As another example, the evaluation may comprise data formatted in a manner similar to the submission score. For instance, if the submission score was formatted as a number between 1 and 100 (e.g., 86.5), the evaluation might be formatted as a desired/recommended new score and/or change to the existing score (e.g., an increase to 89 or a decrease to 84). As another example, if the submission score was formatted as a location on a ranked list of submissions, the evaluation might be formatted as an updated placement/rank on the list.

For instance, operation 207 may include receiving signals via a touch-sensitive screen, a computer mouse, a keyboard, and/or a voice-controlled interface. For example, operation 207 may include receiving information input via a web form, UI, or the like. In this example, operation 207 might include receiving signals indicative of the first account holder entering information via a UI accessible by logging into the first account. For example, the evaluation may be entered via a fillable form, a drag and drop placement, a pick-list, a star rating, or the like. Further examples of receiving digital signals indicative of a particular input should be understood as example implementations of operation 207.

The example process may include, for example, operation 208, which includes updating the processing operation based, at least in part, on the evaluation. For example, operation 208 may include adding or removing terms or phrases from positive or negative feature sets, modifying point values for various scoring factors such as increasing or decreasing point values for the submission category, retraining learning operations using the evaluated submission as a training input, or the like. A further example of operation 208 is discussed further below. Accordingly, after updating the processing operation, subsequent applications of operation 205 to future submissions may result in improved scoring that more accurately predicts the first account holder's priorities.

Attention is now drawn to FIG. 3, which is a flow diagram illustrating an implementation of an example process that may be performed, in whole or in part, to facilitate and/or support one or more operations and/or techniques for infrastructure for on-line collaboration and electronic submission evaluation. For instance, the flow diagram of FIG. 3 may be performed by a device used by a recipient account holder to interact with a infrastructure for on-line collaboration and electronic submission evaluation. For example with reference to FIG. 1, the flow may be performed by an application instantiated on a user device 102, 103, 104, 105, a web-based application instantiated on a server 107, 111, or combinations thereof. Even though one or more operations are illustrated and/or described concurrently and/or with respect to a certain sequence, other sequences and/or concurrent operations may be employed. In addition, although the description below references particular aspects and/or features illustrated in certain other figures, one or more operations may be performed with other aspects and/or features.

The example process may include, for example, operation 301, which includes receiving one or more digital signals indicative of a recipient account. For instance, operation 301 may be performed as described with respect to operation 201 of FIG. 2. For example, operation 301 might include receiving signals indicative of one or more e-mail addresses associated with the accounts and/or registration information associated with the accounts. Further examples of receiving digital signals indicative of a particular input should be understood as example implementations of operation 301. For example, operation 301 may include receiving recipient account information input via a web form, user interface (UI), or other like. As an example with respect to the environment of FIG. 1, operation 301 may include may include receiving signals indicative of a recipient account via a touch-sensitive screen, a computer mouse, a keyboard, and/or a voice-controlled interface of a user device 102, 103, 104, 105. As another example, operation 301 may include an application residing on a server 111, 107 receiving signals from a user device 102, 103, 104, 105. Further examples of operation 301 are discussed below.

The example process may include, for example, operation 302, which includes making available a submission based, at least in part, on a submission score. For instance, operation 302 may be performed as described with respect to operation 206 of FIG. 2. As an example with respect to the environment of FIG. 1, operation 302 may include may include an application and/or webpage presenting information indicative of the submission on a user device 102, 103, 104, 105. As another example, operation 302 may include a server application residing on a server 107, 111 transmitting information to a user device 102, 103, 104, 105 for presentation. As discussed with respect to FIG. 2, the information may be made available to a recipient account holder in various manners. For example, operation 302 may include presenting a number of submissions in a list, table, frame, or the like that is ordered based, at least in part, on submission score. As another example, operation 302 may include presenting group-level information summarizing a number of submissions and/or their associated submission scores in a word cloud, tree map, chart, or the like. Further examples of operation 302 are discussed below.

The example process may include, for example, operation 303, which includes receiving one or more digital signals indicative of an evaluation of the submission. For example, operation 303 may be performed as described with respect to operation 207 of FIG. 2. As an example with respect to the environment of FIG. 1, operation 303 may include receiving signals via a touch-sensitive screen, a computer mouse, a keyboard, and/or a voice-controlled interface of a user device 102, 103, 104, 105. For example, operation 303 may include receiving information input via an interactive element presented on the user device, such as a web form, UI, or the like. As another example, operation 303 may include a server 107, 111 receiving the evaluation from a user device 102, 103, 104, 105. Further examples of operation 303 are discussed below.

The example process may include, for example, operation 304, which includes causing an update to submission scoring processing operations based, at least in part, on the evaluation. For example, operation 304 may include causing the performance of operation 208 of FIG. 2. For instance, operation 304 may be performed via receiving digital signals indicative of a processing update request, such as receiving a signal from an HTML <button> or other interactive element. As another example, operation 304 may be performed responsive to operation 303. For instance, the entry of the evaluation score via a UI may cause the update to the submission scoring operations. Further examples of operation 304 are discussed below.

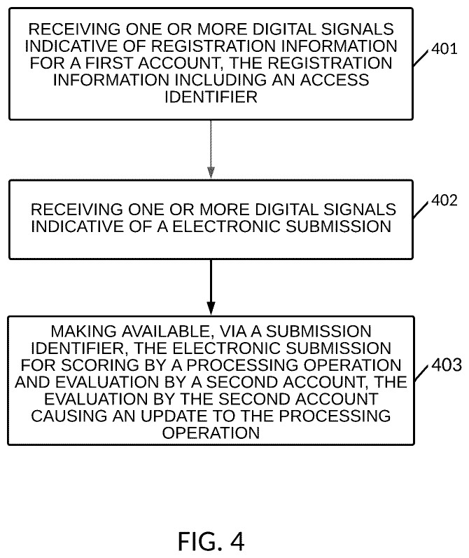

Attention is now drawn to FIG. 4, which is a flow diagram illustrating an implementation of an example process that may be performed, in whole or in part, to facilitate and/or support one or more operations and/or techniques for infrastructure for on-line collaboration and electronic submission evaluation. For instance, the flow diagram of FIG. 4 may be performed by a device used by a user account holder to interact with a infrastructure for on-line collaboration and electronic submission evaluation. For example with reference to FIG. 1, the flow may be performed by an application instantiated on a user device 102, 103, 104, 105, a web-based application instantiated on a server 107, 111, or combinations thereof. Even though one or more operations are illustrated and/or described concurrently and/or with respect to a certain sequence, other sequences and/or concurrent operations may be employed. In addition, although the description below references particular aspects and/or features illustrated in certain other figures, one or more operations may be performed with other aspects and/or features.

The example process may include, for example, operation 401, which includes receiving one or more digital signals indicative of registration information for a first account. The registration information may include an access identifier for a second account. For instance, operation 401 may be performed as described with respect to operation 202 of FIG. 2. For example, operation 401 might include receiving signals indicative of one or more e-mail addresses associated with the accounts and/or registration information associated with the accounts. For example, operation 401 may include receiving first account information and the access identifier as input via a web form, user interface (UI), or other like. As an example with respect to the environment of FIG. 1, operation 401 may include may include receiving signals indicative of the first account via a touch-sensitive screen, a computer mouse, a keyboard, and/or a voice-controlled interface of a user device 102, 103, 104, 105. As another example, operation 401 may include an application residing on a server 111, 107 receiving signals from a user device 102, 103, 104, 105. Further examples of operation 401 are discussed below.

The example process may include, for example, operation 402, which includes receiving one or more digital signals indicative of a submission. For instance, operation 402 may be performed as described with respect to operation 203 of FIG. 2. As an example in the environment of FIG. 1, operation 402 may include a user device 102, 103, 104, 105 receiving the submission via a web-form. As another example, operation 402 may include a server 111, 107 receiving the submission from a user device 102, 103, 104, 105. For instance, the submission received in operation 402 may include one or more categorical identifiers, such as the categories discussed above with respect to operation 201, submission type identifiers (e.g., whether the submission is an idea, an observation, a suggestion, a constructive comment, or the like), or the like. The submission may include one or more narrative or survey-type fields, such as a summary field, a detailed description field, one or more fields responding to customized prompts or questions, a field identifying a prior submission, or the like. The submission may include one or more process-related fields, such as fields indicating whether or not the submission should be treated as an anonymous submissions, whether the user is receptive to submission responses, to which second account the submission should be directed, or the like. Further examples of operation 402 are discussed below.

The example process may include, for example, operation 403, which includes making the submission available for scoring by processing operations and evaluation by the second account. In this example, the submission is made available according to a submission identifier. The evaluation by the second account causes an update to the processing operation used to score the submission. For instance, operation 403 may be performed by triggering or performing operations 205, 207, and 208 as described with respect to FIG. 2. As an example in the environment of FIG. 1, operation 403 may include a user device 102, 103, 104, 105 transmitting a received submission to the server 111, 107 for presentation and evaluation by the second account, followed by the server 111, 107 updating the processing operation. As another example in this environment, operation 403 may include the server 111, 107 making the submission for evaluation and scoring update in response to receiving the submission from a user device 102, 103, 104, 105. Further examples of operation 403 are discussed below.

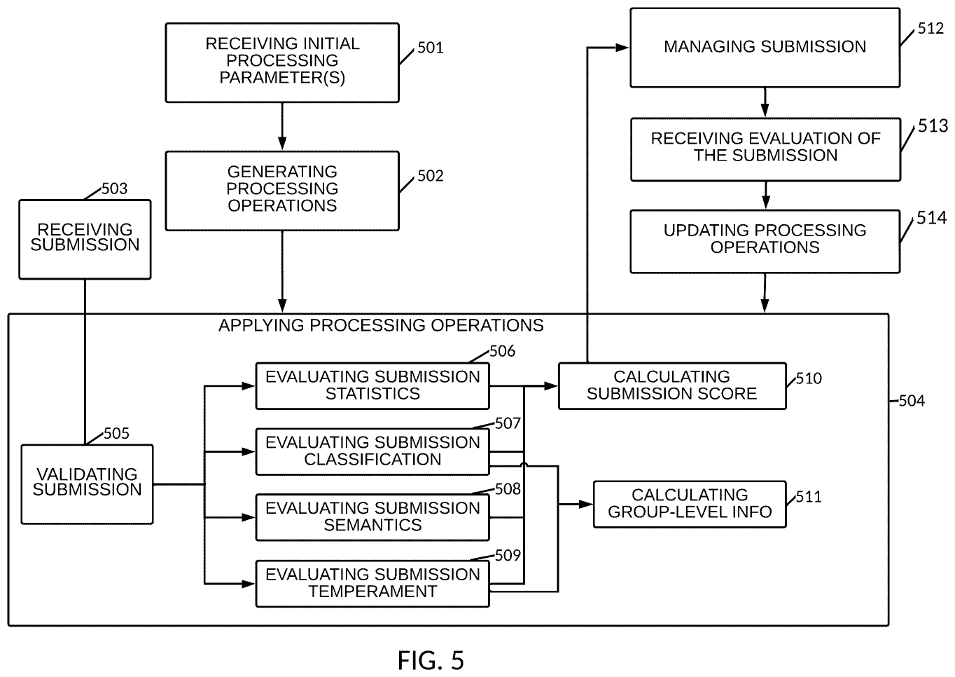

Attention is now drawn to FIG. 5, which is a flow diagram illustrating an implementation of an example process that may be performed, in whole or in part, to facilitate and/or support one or more operations and/or techniques for infrastructure for on-line collaboration and electronic submission evaluation. For instance, the flow diagram of FIG. 5 may be performed by a computing system instantiated on one or more servers to apply processing operations to electronic submissions. For example, with reference to FIG. 1, the flow may be performed by a data center 106, 112 via executed software on or distributed among servers 107, 111. Even though one or more operations are illustrated and/or described concurrently and/or with respect to a certain sequence, other sequences and/or concurrent operations may be employed. In addition, although the description below references particular aspects and/or features illustrated in certain other figures, one or more operations may be performed with other aspects and/or features.

The example process may include, for example, operation 501, which includes receiving one or more initial processing parameters for a submission evaluation processing operation. For instance, operation 501 may be performed as an aspect of system initialization, system update, processing operation retraining, or the like. For example, operation 501 may be performed as discussed above with operation 201 of FIG. 2 or 301 of FIG. 3 as an aspect of account registration. As another example, operation 501 may be performed as an aspect of a processing operation such as retraining, reconfiguring, and/or the like.

In some instances, operation 501 may include receiving signals ranking a set of provided categories, a subset of categories selected from a larger set, a set of user-defined categories, a combination thereof, and/or the like. The ranking may provide default guidelines for scoring submissions that fall under the category, such that, absent other differentiating features, a submission under a higher-rated category is given a higher score than a submission under a lower-rated category. For instance, in an enterprise deployment, operation 501 may include receiving signals ranking a provided set of categories, such as {“strategy”, “process”, “product”, “tools”, “culture”, “personnel”, “other”} and/or other like categories from a highest to lowest priority. In this instance, operation 501 may also include receiving signals adding other categories as chosen by the first account holder or other administrator. In some instances, operation 501 may include receiving signals indicative of other categorical parameters. For example, operation 501 may include receiving signals selecting, adding, and/or giving a priority ranking to a set of submission types, such as {“idea”, “observation”, “constructive comment”} and/or the like. As another example, operation 501 may include receiving signals selecting, adding, and/or giving a priority ranking to a set of temporal categories when a submission should be addressed, such as {“ASAP”, “this month”, “this quarter”, “this year”, “next year”} and/or the like.

In some instances, operation 501 may include receiving signals related to keyword parameters. “Keyword” refers to any word, phrase, term, expression, linguistic constituent, compound, and/or the like that may be used by a processing operation to aid in processing a field, a submission, and/or other text. For example, operation 501 may include receiving signals ranking a set of keywords, classifying a set of keywords, selecting a subset of provided keywords, providing a set of keywords, combinations thereof, and/or the like. As another example, operation 501 may include receiving signals that rank certain keywords against other keywords. In some examples, operation 501 may include receiving signals establishing sets of positive and/or negative keywords. For example, operation 501 may include receiving signals that sort keywords into one or more positive classes that positively impact a submission's evaluation and/or one or more negative classes that negatively impact a submission's evaluation. As an example, operation 501 may include signals inputting and/or selecting one or more positive key words such as “efficiency”, “boost”, “team engagement”, “can”, “team”, “together”, “admire”, “grow”, “trust”, “value”, “revenue generating”, “progress”, “quality”, “consistent”, “generous”, “insight”, “encourage”, “confident”, “creative”, “bright”, “dependable”, “sincere”, “impactful”, “organized”, “diligent”, “passion”, “talented”, “skilled”, “lead”, “logic”, “reason”, and/or the like. As another example, operation 501 may include signals inputting and/or selecting one or more negative key words such as “stupid”, “I don't care”, “can't, “cannot”, “not”, “me”, “lazy”, “worthless”, “not my job”, “not fair”, “unfair”, “jerk”, “idiot”, “dislike”, “hate”, pejoratives, vulgarities, and/or the like. In some examples, such as in an implementation with multidimensional scoring, multiple sets of positive and/or negative keyword sets may be provided according to a desired influence on different scores. For example, an implementation may incorporate a processing operation to score the quality of submissions and a processing operation to determine an organizational sentiment from submissions. This example might utilize first sets of positive and/or negative keywords associated with submission quality, second sets of positive and/or negative keywords associated with organizational sentiment

As a further example, operation 501 may include receiving signals that establish keywords that, when present, may disqualify a submission, flag a submission for manual processing and/or immediate review, and/or the like. As an example, such keywords may include, for example, violence-related keywords such as “hate”, “kill”, “shoot”, “attack”, “gun”, and/or the like. As another example, such keywords may include nuisance-related keywords such as “be your own boss”, “once in a lifetime”, “risk-free”, and/or the like. As another example, such keywords may include personal information and/or other privacy-impacting keywords.

In some instances, operation 502 may include receiving signals providing example submissions and corresponding scores. For example, in an enterprise deployment, operation 502 may include receiving a corpus of prior employee comments, reports, survey responses, or the like, along with example scores for the items.

The example process may include, for example, operation 502, which includes implementing a processing operation for evaluation of submissions. For instance, the processing operation may be as described with respect to operations 205 and 208 of FIG. 2, operation 304 of FIG. 3, and/or operation 403 of FIG. 4. As an example in the environment of FIG. 1, operation 502 may include one or more servers 107, 111 executing software code to implementing the processing operation. In some examples, operation 502 may include modifying preexisting generalized processing operations in accordance with the parameters provided in operation 501 For example, operation 502 may include updating or retraining a pretrained learning operational system according to new examples, revising default scoring values and/or ranking values according to keywords and/or categories, and/or the like. In other examples, operation 502 may include developing new processing operations for the reporting infrastructure. For example, operation 502 may include computing an initial statistical classification based on provided keywords and/or example texts, computing a supervised and/or unsupervised learning operational system, and/or the like.

Operation 502 may be performed in various manners according to the processing operation types. For example, operation 502 may include assigning scoring values to categories or keywords based, at least in part, on selections, point values, and/or rankings provided in operation 501 and/or default values. As another example, operation 502 may include creating or revising statistical classifiers according to provided keywords and/or default keywords. As a further example, operation 502 may include training or retraining a supervised learning operational system using examples received in operation 501. Further described examples of processing operations have corresponding implementation operations and should be understood as example implementations of operation 502.

The example process may include, for example, operation 503 which includes receiving a submission 503. For example, operation 503 may include receiving a submission associated with a corresponding submission identifier, as discussed with respect to operations 203 and 204 of FIG. 2 and/or operation 403 of FIG. 3. As an example in the environment of FIG. 1, operation 503 may include a server 107, 111 receiving a submission from a user-device 102, 103, 104, 105. Further described examples of receiving a submission should be understood as example implementations of operation 503.

The example process may include, for example, operation 504, which includes applying a processing operation to the submission received in operation 503. For instance, operation 504 may be performed as described with respect to operation 205 of FIG. 2. As an example in the environment of FIG. 1, operation 504 may include one or more servers 107, 111 executing software code to apply the processing operation to the received submission. In the example process of FIG. 5, operation 504 includes scoring operations 505-511 as described below. In other implementations, operation 504 may include a subset of these operations, additional operations, and/or different operations according to the specific set of processing operations computed in operation 502, as described above. Accordingly, further descriptions of applying processing operations should be understood as examples of operation 504.

Example operation 504 may include, for example, operation 505, which includes validating the submission received in operation 503. As an example, operation 505 may include determining whether the submission should be flagged and/or redirected for urgent review. For instance, a submission might be flagged and/or redirected if it contains violence-related keywords. As another example, operation 505 may include flagged and/or removed from further processing as a nuisance or “junk” submission. As a further example, operation 505 may invalidating the submission if it contains personal information and/or restricted items such as hyperlinks.

As another example, operation 505 may include applying a duplicate-submission analysis to determine if the submission repeats the content and/or meaning of a prior submission. For example, operation 505 may include comparing the received submission to other submissions to calculate a percentage of duplicate and/or similar words between the received submission and a prior submission. In this example, if the duplicate percentage exceeds a threshold (such as 80%), which may be a default or configured parameter, the submission is flagged as a potential duplicate. In other examples, operation 505 may include comparing the submission to past submissions via various other metrics, such as a Jaccard similarity analysis, a cosine or other vector-based similarity analysis, and/or the like. In some cases, the set of prior submissions may be limited according to some condition. For example, operation 505 may include comparing the received submission to other submissions received in the last X months, days, weeks, or the like, where X is a threshold number. In this example, operation 505 may include performing further operations on such duplicate submissions. For example, operation 505 may include making the duplicate submission available to the user account from which it was submitted for editing and/or notification that the submission was removed as a duplicate. As a further example, operation 505 may include revising the prior submission which was duplicated. For example, operation 505 may include increasing the duplicated submission's score, modifying its availability to the first account (for example, by highlighting and/or refreshing its position a submission list), and/or the like.

Example operation 504 may include, for example, operation 506, which includes evaluating statistics related to the submission received in operation 503. For example, operation 506 may include determining a word and/or character count of the submission, an average sentence word and/or character count, and/or the like. In some instances, operation 506 may include comparing the statistics to thresholds and increasing or decreasing the submission score based, at least in part, on the results of the comparison. As an example with processing operations assigning points to different criteria, operation 506 may include awarding points if the average sentence word count is between a lower bound and an upper bound (e.g., indicating the submission does not use run-on or fragment sentences). In this example, operation 506 may include decrementing points if the average word count is less than the lower bound (indicating sentence fragments) or greater than the upper bound (indicating run-on sentences or lack of punctuation). In some instances, operation 506 may include providing the statistics as a value, such as a raw value, a bucketed value, or the like, for subsequent score determination. Other examples of evaluating text based on text statistics should be understood as examples of operation 506.

Example operation 504 may include, for example, operation 507, which includes evaluating the electronic submission based on a submission classification. As an example, operation 507 may be based on user submitted and/or selected information, such as a category and/or type as discussed with respect to operation 203 of FIG. 2. As another example, operation 507 may include performing a classification operation on the submission, such as a support vector classification (SVC), logistic regression, or the like. In some examples, operation 507 may include scoring the submission based on the classification. For example, operation 507 may include awarding the submission a score based its category and a category ranking or category point values received in operation 501. As an example, operation 507 may include awarding the submission a number of points based on point values provided for available categories. In some examples, operation 507 may include performing various scoring operations based on the submission classification. For example, operation 507 may include using the classification to determine a cohort of prior submissions having the same classification with which to compare the submission. As another example, operation 507 may include selecting different processing operations based on the submission classification. Other examples of scoring text based on classification operations should be understood as examples of operation 507.

Example operation 504 may include, for example, operation 508, which includes evaluating semantics of the electronic submission. In some examples, operation 508 may include performing a keyword analysis against a set of semantic keywords as discussed with respect to operation 502. As an example, operation 508 may include increasing a submission score and/or awarding points to a submission if the submission contains keywords found in a positive keyword set. An example of such a keyword set may include keywords such as “efficiency”, “boost”, “team engagement”, “improve”, “benefit from”, and/or the like. Similarly, operation 508 may include decreasing a submission score and/or decrementing points from a submission if the submission contains keywords found in a negative keyword set. An example of such a keyword set may include keywords such as “stupid”, “unfair”, “I don't care”, “waste of time”, and/or the like. In some cases, keyword values may be established as described with respect to operation 501 and 502. As another example, keyword values may be established during an earlier processing operation update, as discussed below with respect to operation 514.

Other like keyword evaluations may be performed as aspects of operation 508. For example, operation 508 may include calculating a ratio of positive keywords to negative keywords as a scoring output. For instance, operation 508 might include calculating a first weighted sum of the positive keywords in the submission and a second weighted sum of the negative keywords, weighted by keyword values associated with the individual keywords. In some cases, the weights might be normalized by the total sum of keyword values or other normalization factors. In this example, the ratio of positive keywords to negative keywords may be provided as the first weighted sum divided by the second weighted sum. In such an example, a ratio greater than 1 may indicate a submission with a positive language value greater than its negative language value. Similarly, a ratio less than 1 may indicate a submission with a positive language value less than its negative language value.

As further examples, operation 508 may be performed based, at least in part, on various text semantics evaluation operations, such as specificity evaluations, semantic keyword analyses, natural language processing operations, supervised and/or unsupervised learning operations, or the like. For instance, operation 508 may include applying supervised learning operations to score the submission against a training set include prior submissions and corresponding scores. Other examples of scoring text based on semantic processing operations should be understood as examples of operation 508.

Example operation 504 may include, for example, operation 509, which includes evaluating temperament of the electronic submission. In some examples, operation 509 may include performing a keyword analysis against a set of temperament-related keywords as discussed with respect to operation 502. As an example, operation 509 may include increasing a submission score, awarding points to a submission, calculating a weighted sum, and/or the like based on submission keywords found in a positive keyword set. An example of such a keyword set may include keywords such as “can”, “team”, “together”, “admire”, “grow”, “trust”, “value”, “progress”, “quality”, “consistent”, “generous”, “insight”, “encourage”, “confident”, “creative”, “bright”, “dependable”, “sincere”, “impactful”, “organized”, “diligent”, “passion”, “talented”, “skilled”, “lead”, “logic”, “reason”, and/or the like. Similarly, operation 509 may include decreasing a submission score and/or decrementing points from a submission if the submission contains keywords found in a negative keyword set. An example of such a keyword set may include keywords such as “can't”, “cannot”, “not”, “me”, “lazy”, “worthless”, “not my job”, “not fair”, “unfair”, “jerk”, “idiot”, vulgarities, pejoratives, and/or the like. In some cases, keyword values may be established as described with respect to operation 501 and 502. As another example, keyword values may be established during an earlier processing operation update, as discussed below with respect to operation 514.

Other like keyword evaluations may be performed as aspects of operation 509. For example, operation 509 may include calculating one or more pairwise ratios of positive sentimental terms and their antonyms. For instance, operation 509 might include calculating a ratio of the number of uses of the keyword “we” to the number of uses of the keyword “I”, a ratio of the number of the uses of the keyword “win” to the number of uses of the keyword “lose”, and/or the like. As further examples, operation 508 may be performed based, at least in part, on various text temperament evaluation operations, such as specificity evaluations, sentiment keyword analyses, natural language processing operations, supervised and/or unsupervised learning operations, or the like. For instance, operation 508 may include applying supervised learning operations to score the submission against a training set include prior submissions and corresponding scores. Other examples of scoring text based on temperament processing operations should be understood as examples of operation 509.

Example operation 504 may include various further processing operations, which may be performed as aspects of operations 506-509 and/or as additional operations. For example, operation 504 may include performing a writing quality analysis on the electronic submission. Such a writing quality analysis may be performed via various text processing operations, such as natural language processing or the like. In one example, the writing quality analysis may be configured to bucket the results into a rating scale (e.g., a 1-5 or 1-10 scale) to produce a number of additional (e.g., “bonus”) points that are added to the score. As another example, the results of the writing quality analysis may be used to produce a weighting factor that is applied to other processing operation results. For example operation 504 may include computing a weighting percentage based on a degree of introversion or extroversion, and/or other personality trait that the submission demonstrates. For instance, operation 504 may include mapping the output of a personality trait detection operation to a weighting percentage. As an example, an introversion/extroversion operation might output a scaled value between 0-1, 1-10, 1-100, or the like, with one end the scale indicating a most introverted submission and the other end indicating a most extroversion submission. In this example, the scaled values may then be mapped to certain percentages, such as mapping the most introverted quartile to a positive percent (e.g., 10% to 20%) and the most extroverted quartile to a negative percent (e.g., −10% to −20%). Accordingly, in this example, an introverted submission will have an increased score compared to an extroverted submission, with all other factors being equal, which may compensate for an introverted submission's tendency to understate the importance and/or value of their report and an extroverted submission's tendency to overstate the importance and/or value of their report. Similarly to the other scoring parameters discussed herein, such a weighting mapping may be preconfigured as a general system parameter, specifically configured as a initialization parameter of a specific system instance, a value that is updated via a processing operation update, and/or the like. Of course, further examples of operation 504 may utilize various other text evaluation processing operations, such as positive vs. negative sentence utilization, OCEAN (openness, conscientiousness, extroversion, agreeableness, neuroticism, i.e., the “Big 5”) evaluation, Myers-Briggs test indicators (MBTI), language intensity evaluation, or the like. The results of such evaluations may be computed as independent scores, weights to other scores, and/or other like scoring factors. These and other like text evaluation operations should be understood as examples of operation 504.

Example operation 504, may include, for example, operation 510, which includes calculating a submission score for the electronic submission. Operation 510 may include computing the score via the results of operation 506-509 or other processing operations. For example, operation 510 may include combing the outputs of operations 506-509 as a mean, a sum, a weighted sum, a product, a weighted product, a geometrical mean, or the like. As further examples, operation 510 may include combing the results of the scoring operations 506-509 in other manners, such as by averaging the semantics and temperament scores and multiplying the result by weighting factors computed by submission classification and submission statistic evaluation operations. In some examples, operation 510 may include producing a multidimensional score. For instance, operation 510 may include producing a tuple of the results of each of the scoring operations, producing a pair of scores include a semantic score weighted by the submission classification score and a temperament score weighted by the submission statistics score. In other examples, various other functions may be applied to the results of previous scoring operations to compute the submission score, any of which should be understood as examples of operation 510.

Example operation 504, may include, for example, operation 511, which includes calculating group-level information. For example, operation 511 may include calculating an overall organizational sentiment-related score based on a set of submissions. For instance, operation 511 may include calculating a running average of the outputs of one or more of the scoring operations 506-509 over a configured or preset time period. As an example, operation 511 may calculating the average percent of each of the different submission classifications and/or categories (e.g., that X % of the submissions last quarter were related to strategy, that Y % of the submissions last quarter were related to HR/personnel issues, etc. . . ). As another example, operation 511 may include calculated an organizational score over a selected period of time based on an overall keyword match percentage, language review score, and/or the like. In some examples, operation 511 may be performed based on the same, different, and/or overlapping scoring operations as in operation 510. For instance, in the illustrated example, operation 511 is based on submission classification scores from operation 507 and submission temperament scores from operation 509.

In some implementations, operation 511 may include other group-level summary information. For example, operation 511 may include computing one or more charts based on keyword frequency, such as a word cloud, donut chart, circle packing chart, tree map, or the like. For instance, such a chart may be based on one or more of the keyword sets used in operation 508 and/or operation 509. As discussed with respect to operation 512, such a chart may be customizable by the viewer (e.g., the first account). In which case, operation 508 may include computing the chart based on selected options, such as time periods, categories, key word sets, and the like (e.g., operation 508 might include computing keyword frequency data for the positive semantic keyword set over the last fiscal year for submissions in the “strategy” category and “idea” classification).

As another example, operation 511 may include determining trending keywords that are associated with high-rated or low-rated submissions. For example, operation 511 may include maintaining a positive trending list of keywords that are found in high-rated submissions (e.g., submissions rated 4 or 5 in a 5 point scale) and a negative trending list of keywords that are found in low-rated submissions (e.g., submissions rated 1 or 2 in the 5 point scale). For instance, operation 511 may include maintaining a list of the top N keywords found in high-rated submissions and a list of the top Mkeywords found in low-rated submissions. In various implementations, these lists may filtered according to various criteria. For example, they may exclude keywords already found in positive or negative keyword lists, and/or they may be limited to semantic or temperament-related keywords. For instance, such lists may be presented to via the first account to enable the account holder to add keywords to the corresponding keyword sets. Other examples computing summary-type information should be understood as examples of operation 511.

The example method may include, for example, operation 512, which includes managing the electronic submission based, at least in part, on the submission score. In some implementations, operation 512 may include making available the submission based, at least in part, on the submission score. For instance, the data may be made available as discussed with respect to operation 206 of FIG. 2, operation 303 of FIG. 3, and/or operation 403 of FIG. 4. As an example in the environment of FIG. 1, operation 512 may include one or more servers 107, 111 computing the data and/or one or more user devices 102, 103, 104, 105 displaying the data. As an example, operation 512 may include making the submission available to a user device connected to the first account. As a further example, operation 512 may include making the submission to one or more devices connected to subsidiary accounts. For instance, the submission may be made available to a subsidiary account in response to the recipient account forwarding the submission. As another example, operation 512 may include making the submission available to other submitter accounts. For instance, the submitting user account may provide an indicator that their submission should be made available to other submitter accounts on an organization-wide dashboard or the like.

In some examples, operation 512 may include presenting a set of submissions in a dynamic manner. For example, operation 512 may include making data available for presenting a dashboard, which may include submissions within a subset of the available categories and/or classifications, submissions having at least or at most a selected threshold score, submissions having been received over a configurable time period (such as j days, k quarters/years, or the like), or other like filtering and/or grouping conditions. As another example, operation 512 may include making available data for presenting submissions according to whether or not they have been viewed, rated, and/or responded to by the viewing account.

In some implementations, operation 512 may include performing further submission handling operations, such as automatically responding to the submission, archiving the submission, and/or the like. As an example, submissions may include have an active or archived status, where submissions begin as active and are placed into the archived status based on various rules. Various examples may utilize various such archival rules. For example, the first account may be provided an interface for configuring archival, such as selecting different lengths of time for different submission categories and/or different submission scores. For instance, submissions might be divided into different score level groups, such as high, medium, low, with each group having a different archival time (e.g, high-rated submissions might remain active for X days, medium-rated submissions might remain active for Y days, and low-rated submissions might remain active for Z days). In such instances, X, Y, and Z may be configurable (e.g., by the first account holder) and/or calculated based on various conditions, such as the number of total submissions (e.g., a higher volume of total submissions may be configured to increase (or decrease) X, Y, and Z, while a lower volume of total submissions may be configured to decrease (or increase) X, Y, and Z).

In further examples, other archival related user experience (UX) designs may be implemented. For example, submissions may be highlighted based on upcoming archival (e.g. green status for submissions that will be archived in J days, yellow status for submissions that will be archived in J+K days, and red status for submissions that will be archived in J+K+L days), where relevant parameters may be configured and/or automatically computed based on submission volume and/or other characteristics. In such examples with such archival rules, various user interface elements may be provided to manually control the archival (e.g. by “pinning” a submission to remain on the list), provide rules to avoid archival (e.g. by configuring a number of highest-scored submissions that are excepted from archival), or the like. In further examples, operation 512 may include making the archived submissions available to the first account. For example, operation 512 may include making available an archived message folder, view, or the like. Such a presentation may include other features, such as separating and/or indicating archived messages that have been viewed from ones that have not been viewed.

In some examples, operation 512 may include providing an automated response to the electronic submission. For example, operation 512 may include sending a message the associated user account in response to the submission being archived, received, viewed, or the like. In some examples, the automated response may be selected and/or computed according to the associated submission score.

For example, the submissions may be divided into quantiles (e.g., dividing the submissions into 2, 3, or 4 groups) based on their submission scores. As an example, a response to a submission in an upper quantile may include a message indicating that the submission will be reviewed and possibly acted upon, that the submission was high-valued and that the submitter should provide further submissions, and/or the like. In this example, an automated response to a submission in the lower quantile may include a message that the submission is unlikely to be reviewed and/or encouraging the submitter to provide future submissions, and/or the like. Other such responses to submissions may be provided in accordance with the associated user scores and should be understood as examples of operation 512.

As another example, an automated response may be computed based on the specific output of a processing operation 506-509. For instance, responsive to operation 506, such as detecting a threshold number of sentence fragments, a threshold percentage of sentence fragments, or the like, a response might be sent to the user account requesting that the user resubmit the submission with a more detailed narrative. As another example, responsive to operation 507 and 508, such as detecting a potential miscategorization given a certain semantic content (e.g., a product-related idea submitted to an HR-related category, or the like), a response might be sent to the user account informing them of the detected potential miscategorization and requesting that the user resubmit the submission under the correct category. In some examples, responsive to operation 508, a response might be sent informing the user of a more appropriate reporting channel. For example, if operation 508 detected a submission related to harassment or an inappropriate relationship between coworkers, the response might direct the user to report the situation directly to HR. As another example, if operation 508 detected a submission related to bribery or a conflict of interest, the response might direct the user to report the situation directly to a legal department.

The example process may include, for example, operation 513, which may include receiving one or more digital signals indicative of an evaluation of the electronic submission. For instance, operation 513 may performed as described with respect to operation 207 of FIG. 2, operation 303 of FIG. 3, and/or operation 403 of FIG. 4. As examples in the environment of FIG. 1, operation 513 may be performed by a user device 101, 102, 103, 104, 105 connected to a primary account, a subsidiary account, and/or a submitter account, and/or operation 513 may be performed by a server 107, 111 connected to one or more of such devices.

Operation 513 may be performed in various manners. For example, operation 513 may include receiving the signals indicative of the submission evaluation via a field in a web form, a dedicated application, or the like. For example, the evaluation may be received via a fillable form, a drag and drop placement, a pick-list, a star rating, or the like. In some cases, the evaluation may be accompanied by narratives indicative of a value of the submission. As a particular example in an enterprise environment, evaluations may be entered via selection from a scale such as: {1: Interest Generated; 2: Looks Promising; 3. Very Stimulating; 4: Impactful; 5: Diving-in Immediately}. In some examples, operation 513 may include signals indicative of multiple dimensions of evaluation scores. For instance, separate scores may be provided for the submission value, the submission writing quality, the submission novelty, and/or the like. In some cases, operation 513 may include receiving signals indicative of one or more evaluations of the accuracy of the processing operation. For instance, operation 513 may include receiving an evaluation of the accuracy of a semantic analysis performed in operation 508 or a temperament analysis performed in operation 509. In some implementations, operation 513 may include receiving further evaluation-related elements. For example, operation 513 may include receiving a freeform text response to the submission via a comment field or the like. As another example, operation 513 may include receiving a request for a follow-up or addendum to the submission and/or a request for the user account to consent to removing the anonymity of the submission.

In some implementations, operation 513 may include making feedback available to the user account in response to the submission. For example, the feedback may include the evaluation score, a narrative indicative of the evaluation score, or the like. For instance, the feedback may include the evaluation and any comments or other narrative provided by the reviewer. If the evaluation included a request for the user account to consent to removing anonymity, the feedback may include that request. For instance, in the particular enterprise example discussed above, the feedback may include a narrative such as “The CEO would like to talk to you about this personally,” or the like. Such examples are discussed further.

The example process may include, for example, operation 514, which includes updating the processing operation based, at least in part, on the evaluation of the submission. For example, operation 514 may be performed as described with respect to operation 208 of FIG. 2, operation 304 of FIG. 3, and/or operation 403 of FIG. 4. As an example in the environment of FIG. 1, operation 514 might be performed by a server 107, 111 responsive to receiving an evaluation of a submission from a user device 102, 103, 104, 105. Operation 514 may be performed in various manners according to different aspects of processing operations applied in operation 504 and their respective parameters. As examples with respect to keyword-based scoring operations, operation 514 may include adding keywords, removing keywords, updating keyword statistics, updating keyword weights, and/or other like modifications to keyword-based scoring parameters. As other examples with respect to learning-based scoring operations, operation 514 may include adding the user evaluation and score to a training corpus, updating decision tree weights, adding or removing decision trees from a random forest, and/or other like modifications to learning-based scoring parameters.

Operation 514 may include using the evaluation received in operation 513 in various manners. For example, operation 514 may include selecting which submissions are used for updating the processing operation based on their associated scores. As an example with respect to a system having a 1-5 scale ranking, submissions rated the highest (e.g., 4 or 5) and submissions rated the lowest (e.g., 1 or 2) might be used to update the processing operation, while submissions with a middle rating (e.g., 3) would not be selected for processing operation update. As an example with regard to a system utilizing a positive keyword set and a negative keyword set, operation 514 may include adding keywords to the positive set from the higher-rated submissions and adding keywords to the negative set from the lower-rated submissions. In these examples, keywords may be added to or removed from keyword sets based on various statistical measures, such as total counts/tallies, counts of submissions including the keyword at least once, relative frequencies, and/or other statistical measures.

As a particular example in such a system, operation 514 might include maintaining running tallies of terms appearing in higher-rated submissions and running tallies of terms appearing in lower-rated submissions over a period of time. In this particular example, a term might be added to the corresponding keyword set when the term's tally exceeds a certain threshold. A term might be added to the positive keyword set in response to its tally exceeding a positive value threshold and added to the negative keyword set in response to its tally dropping below a negative value threshold. For instance, given a positive threshold of 100 and a negative threshold of −80, a term would be added to the positive keyword set if its tally reaches 100 and would be added to the negative keyword set if its tally drops below −80. Similarly, operation 514 may include removing keywords from keyword sets based on various conditions. For example, a keyword from the positive set might be removed if it does not appear in higher-rated submissions with at least a minimum threshold frequency over a configured time period. Likewise, a keyword from the negative set might be removed if it does not appear in lower-rated submissions with at least a minimum threshold frequency over a configured time period.

As further examples, operation 514 may include updating values for submission classification operations 507. For instance, operation 514 may include increasing or decreasing point values for different categories based on their frequency in higher or lower ranked submissions. In some cases, this may be performed by adjusting the rank order of the categories, modifying raw point values for the categories, assigning positive or negative adjustment factors to various categories, and/or the like.

As a particular example, operation 514 may include maintaining a first distribution of categories for high-rated submissions and a second distribution of categories for low-rated submissions. In this example, if a category exceeds a certain frequency threshold in the first distribution, it may be assigned a positive scoring factor (e.g., a number of additional points). Similarly, if a category exceeds a certain frequency threshold in the second distribution, it may be assigned a negative scoring factor (e.g., a number of decremented points). As a particular example, in a 5 point scaled rating system with a positive threshold of 40% and a negative threshold of 60%, if a category of submissions (e.g., “strategy”) makes up 40% or more of high-rated submissions (e.g., submissions rated 4 or 5) in a certain time period (e.g., a quarter), then that category is assigned a positive scoring factor (e.g., +3 points) such that future submissions in that category are awarded additional points for their submission scores. Similarly, in this example, if a category of submissions (e.g., “tools”) makes up 60% or more of low-rated submissions (e.g., submissions rated 1 or 2) in a certain time period (e.g., a quarter), then that category is assigned a negative scoring factor (e.g., −3 points). In this example, if, as time passes, a category falls back under a threshold frequency, then the corresponding scoring factor is removed from that category.

Parameters for operation 514 may be configured by an administrator and/or a primary account holder, may be preconfigured at system instantiation, may be dynamically determined during system runtime, and/or the like. For instance, in the particular examples discussed above, the account holder may be provided a web portal that includes fields controlling threshold values, time periods, which ratings qualify as high-rated, which rating qualify as low-rated, and/or like parameters, additional point values related to frequent categories, and/or other like parameters.

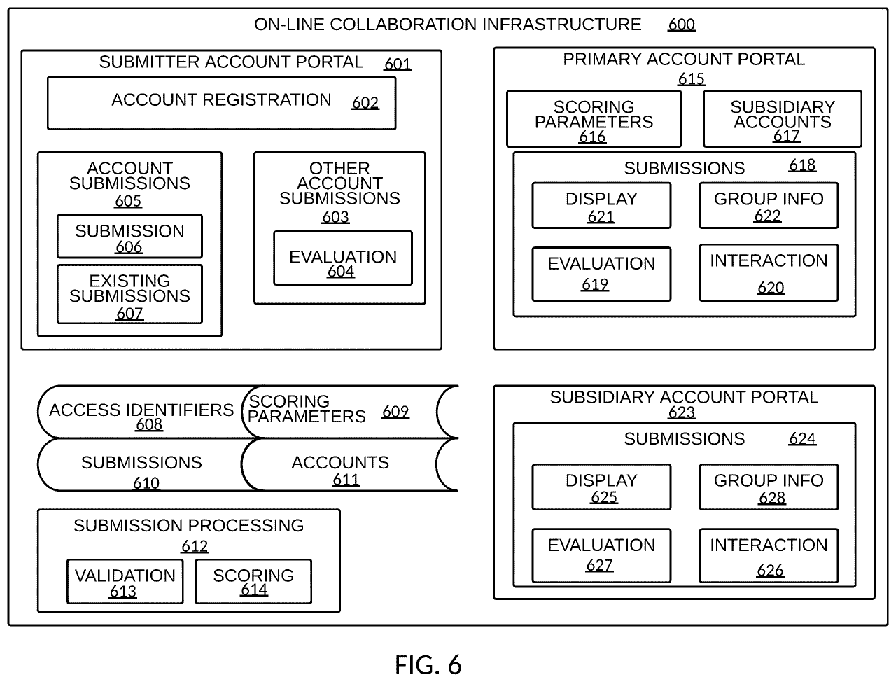

Attention is now drawn to FIG. 6, which is a diagram illustrated features of an example system 600 that may, in whole or in part, facilitate and/or support one or more operations and/or techniques for infrastructure for on-line collaboration and electronic submission evaluation. The example system 600 may include software components comprising computer executable code that, when executed, cause a computing system to operate as described with respect to the component. For instance, the system 600 may include software code that, when executed, cause a computing system to operate in accordance with the example methods described with respect to any or all of the FIGS. 1-5. In some examples, the illustrated system may be implemented via software components deployed in various architectures, such as web-queue-worker architectures, n-tier application architectures, microservice-based architectures, data-driven architectures, and/or the like. Accordingly, while the description of FIG. 6 may be made with reference to certain example environments, such as the environment of FIG. 1, or certain example architectures, the scope of the system is not limited to these examples and should be understood to example environments and/or architectures.

The example system 600 may include, for example, a submitter account portal 601. For instance, in the example environment of FIG. 1, account portal 601 may be implemented via a web client executing on a user device 102, 103, 104, 105 interacting with a web server executing on a server 107, 111. The example user portal 601 provides a user interface for a submitter account to interact with on-line collaboration infrastructure 600.

As illustrated, example submitter account portal 601 includes an account registration interface 602. For instance, account registration interface 602 may be implemented to perform aspects of operation 202 of FIG. 2 and/or operation 401 of FIG. 4. For example, as discussed above, a prospective user may receive an access identifier associated with the system via an out-of-band channel, such as via a personal and/or work email account. In some implementations, the access identifier may be one of a plurality of access identifiers. For instance, a unique access identifier may be provided to each prospective user.

During account registration, the user may provide the access identifier via interface 602 and system 600 may validate the received access identifier against a stored copy 608 of the access identifier. Accordingly, in some cases, account registration may take place without a user device connection to information technology (IT) infrastructure controlled by the organization that will be subject to the submissions (“the organizational IT”). For instance, in the environment of FIG. 1, submitter account registration via interface 602 may take place through a user device 102-103, 104, 105 communicating with a server 107 via a publicly available location on Internet 109. In such cases, the copies of access identifiers 608 may be stored within the organizational IT. For instance, system 600 may include a helper service running on a public-facing server (e.g., server 107) that interfaces with a data-store running on a private/on-premises server (e.g., server 111). In other such cases, the copies of access identifiers 608 may be stored separately from the organizational IT (e.g., on server 107 or other server within datacenter 106).

The example account registration interface 602 may include an interface to receive signals indicative of submitter account credentials, such as usernames, passwords, third-party authentication credentials, and/or the like. For instance, a user may provide an email address (e.g., their personal email address) as a login credential (e.g., as their username or as an email account associated with their username). In some examples, system 600 may perform address verification to restrict users from using an organizational email as a login credential. For example, system 600 may restrict organizational emails to prevent a future loss of anonymity via the organization's access to its members' email accounts. Some example systems 600 may perform further authentication procedures via registration interface 602. For example, registration interface 602 may include fields to perform multi-factor authentication (MFA), such as a field to enter a code sent to a user device via a text message and/or email, a one-time code provided by a third-party authentication app, or the like.

The example submitter account portal 601 may include, for example, an electronic submission management interface 605. As illustrated, submission management interface 605 includes an interface 606 for a user to provide submissions and an interface 607 to interact with system 600 with respect to existing submissions. For instance, in the example environment of FIG. 1, submission management interface 605 may be instantiated on a user device 102, 103, 104, 105 via a website or application served by a server 107 111. In some examples, system 600 may use submission management interface 605 perform the example operations as described with respect to operations203 of FIG. 2, operation 402 of FIG. 4 and/or operations 503, 505, 512, and/or 513 of FIG. 5. As illustrated, the example submission management interface 605 includes a submission interface 606 and an existing submission management interface 607.

The example submission interface 606 provides an interface to receive signals indicative of a submission. For example, submission interface 606 may be configured receive signals and make data available as described with respect to operation 203 of FIG. 2, operation 402 of FIG. 4, and/or operation 503 of FIG. 5. For instance, interface 606 may include various fields of a predetermined digital submission form. For example, the interface may include elements to select and/or enter one or more categorical identifiers, such as the categories discussed above with respect to operation 201, submission type identifiers (e.g., whether the submission is an idea, an observation, a suggestion, a constructive comment, or the like), or the like. The submission interface 606 may include one or more narrative or survey-type fields, such as a summary field, a detailed description field, one or more fields responding to customized prompts or questions, a field identifying a prior submission, or the like. The submission may include one or more process-related fields, such as fields indicating whether or not the submission should be treated as an anonymous submissions, whether the user is receptive to submission responses, to which account the submission should be directed, or the like.

In some examples, submission interface 606 may include information elements to make available information regarding the submission or the submission process. For instance, submission interface 606 may include text describing the primary account holder. For example, in an enterprise deployment with the business leader (e.g., CEO, President, or the like) as the primary account holder, the text may state that the submission will be provided directly to the leader, explain the available categories and/or explain the importance (e.g, information derived from the category ranking and/or values provided by the primary account), explain that the submission will be scored and/or ranked according to business leader inputs and/or explain how the submission will be ranked (e.g., providing an overview of the processing operation and/or input parameters), explain that submissions may be modified and/or resubmitted based on their scores, and/or the like. As a further examples, the text may provide information regarding the anonymity of the submission. For example, the text may inform the user that the submission will be associated with a submission identifier that does not contain personal information (e.g., a random identifier), that their personal email address is used as a login to prevent organization members (e.g., IT personnel) from accessing their account, that any identifiable information (e.g., mappings between their submission identifiers and account identifiers) will be stored in a location that is not directly accessible by the organization (e.g., that such data is stored by a third-party host of the on-line collaboration infrastructure on behalf of the organization), an explanation that the user's express permission is required to remove the anonymity of their submission subject to limited exceptions, an explanation of such exceptions to anonymity (e.g., threatening language, harassment, defamatory and/or sexually explicit material, content in violation of law, a court order and/or other binding procedure, other emergency or exigent situation, and/or the like). As a further example, the interface may include one or more fields that receive a confirmation from the user that they understand and agree to such terms, that they hold the organization and/or third-party harmless, that they are a current member of the organization (e.g., a current employee), and/or the like. Other such typical information content should be understood to be examples of content that may be provided via submission portal 606.

The illustrated example submission management interface 605 may further include an existing submission management interface 607. For example, existing submission interface 607 may make available a list of previous submissions received from the submitter account. Such a list may include various information for the submission, such as the status of the submission (e.g., whether it has been viewed, archived, forwarded to a subsidiary account, and/or the like), a score and/or ranking awarded the submission (e.g., by the primary account holder, a subsidiary account holder, and/or other submitter accounts), whether the primary account holder requests follow-up or for the submitter to reveal their identity, or other like metadata. In some cases, existing submission interface 607 may make system-computed messages available to the account holder. For instance, existing submission interface 607 may display a rating received from the primary account and an accompanying system computed response as described with respect to operation 512 of FIG. 5.

In some examples, existing submission interface 607 may present an interactive element responsive to a primary account requesting that the user reveal their identify. For instance, interface 607 may include explanatory text explaining that the primary account (e.g., the business leader) would like to follow up and/or discuss the submission directly with the submitter account holder along with an interactive element to receive signals indicative of the account holder agreeing to having their anonymity removed. For example, interface 607 may include a field such as a checkbox, drop down menu, or the like to agree to removing the submission anonymity and/or fields to receive signals indicative of various information. For instance, interface 607 may include fields to receive the user's contact information (e.g., name, organization email address, phone number, and/or the like), fields to receive a freeform comment, fields to respond to survey items, and/or the like.

As another example, existing submission interface 607 may include elements to receive signals and make available data with respect to potential duplicate submissions. For example, system 600 may notify the user of a potential duplicate and/or redundant submission in response to validating the submission as described with respect to operation 505 of FIG. 5. In some examples, interface 607 may present information (e.g., text) informing the user that their submission has been evaluated as likely duplicative of a previous submission, which may be a previous submission from their account or another submitter account. The interface 607 may provide interactive elements to receive a modification to the duplicative submission. For instance, the interface 607 may provide an interactive element that returns the submission to the submission form for editing. In some examples, the interface 607 may present information describing the previous submission, such as the summary of the previous submission, a complete copy of the previous submission, or the like. In these examples, the interface 607 may include an interactive element enabling the submitter account to override the evaluation (e.g., a web button stating “this is not a duplicate,” or the like.) In some examples, confirmation of a duplicate submission may cause the on-line collaboration infrastructure 600 to update the evaluation of the previous submission. For example, the on-line collaboration infrastructure 600 may refresh the date of the previous submission (e.g., to extend the time before archival), highlight the previous submission in a primary account portal (e.g., to bring attention to the previous submission), increase the weight accorded the previous submission during processing operation updates, or the like.

The example on-line collaboration infrastructure 600 may include, for example, a primary account portal 615. As illustrated, primary account portal 615 may include, for example, interfaces for configuring scoring parameters 616, managing subsidiary accounts 617, and managing and/or reviewing submissions 622. For example, submission interface 618 may be configured to receive signals and make data available as described with respect to operations 206, 207 of FIG. 2, operation 301-304 of FIG. 3, and/or operations 501, 502, 512, and 513 of FIG. 5. For instance, in the example environment of FIG. 1, primary account portal 615 may be instantiated on a user device 102, 103, 104, 105 via a website or application served by a server 107 111.

The example primary account portal 615 may include, for example, a scoring parameter interface 616. For instance, scoring parameter interface 616 may receive signals indicative of initial scoring parameters as discussed with respect to operation 301 of FIG. 3 and/or operation 501 of FIG. 5. As another example, scoring parameter interface 616 may receive signals indicative of modified scoring parameters during system operation. For example, interface 616 may provide interactive elements to receive modifications to category-associated scoring parameters and/or additional categories, and/or modifications to keyword sets and/or keyword-based scoring parameters.

As an example, scoring parameter interface 616 may present current positive and/or negative keyword sets and interactive elements to receive signals removing and/or adding keywords to the sets. In some examples, interface 616 may present a keyword set in a list, word cloud, tree map, chart, or the like, along with interactive elements to receive signals removing keywords. In some cases, these elements may be formatted based, at least in part, on group level information, such as the keyword statistics discussed with respect to operation 511 of FIG. 5. As an example the words may displayed as displayed text with an underlying hyperlink that triggers removing the word from the list. As another example, the keywords may be displayed as drag-and-drop elements such that may be removed from the sets by a user dragging a keyword out of the displayed set. As a further example, the interface 616 may include a text entry field to receive new keywords, keyword values, and/or the like.

In some examples, scoring parameter interface 616 may include elements to manage potential or recent additions to the keyword sets. For example, as discussed with respect to operation 514 of FIG. 5, updating the processing operation may include adding new keywords to keyword sets, or removing keywords from keyword sets. In these examples, scoring parameter interface 616 may making data available indicative of keywords added and/or removed by past processing operation updates. Additionally, interface 616 may include interactive elements to receive signals indicative of confirming and/or reject the changes. For instance, interface 616 may present separate lists of added and/or removed keywords, and/or may highlight such keywords in lists of the entire keyword sets. As another example, scoring parameter interface 616 may present sets of positive and/or negative trending keywords, as discussed with example operation 511 of FIG. 5. In this example, interface 616 may further include interactive elements to receive signals adding keywords from the trending keyword sets to the positive and/or negative keyword scoring sets. Additionally, interface 616 may include elements to receive signals removing keywords from the trending sets (e.g., to remove them as potential additions to the positive and/or negative keyword scoring sets).

Example primary account portal 615 may include, for example, a subsidiary account management interface subsidiary account management interface 617. Subsidiary account management interface 617 may include interactive elements to receive signals indicative of one or more subsidiary accounts. For example, the subsidiary accounts may be accounts that are granted conditional privileges to certain submissions. In some examples, subsidiary account management interface 617 may include fields to receive contact information of subsidiary account holders, such as workplace emails for prospective subsidiary account holders. In this example, the subsidiary account holders may be invited to establish a subsidiary account via the identification. For instance, the system may compute and transmit an invitation message (e.g., an email) to the prospective subsidiary account holder to enable the provisioning of the subsidiary account. In further examples, subsidiary account management interface 617 may include interactive elements to provision a subsidiary account from within primary account portal 615.

Subsidiary account management interface 617 may include interactive elements to manage existing subsidiary accounts. For example, subsidiary account management interface 617 may include interactive elements to associate subsidiary accounts with categories of submissions. As a particular example in an enterprise deployment, a senior vice-president (SVP) of business development (BD) may be assigned to strategy-related submissions, a chief-of-operations (COO) may be assigned to process-related submissions, a chief commercial officer (CCO)/chief experience officer (CXO) may be assigned to product-related submissions, a chief technology officer (CTO) may be assigned to engineering-related submissions, a chief human resources officer (CHRO) may be assigned to culture-related submissions, and/or the like. Additionally, in some examples, subsidiary account management interface 617 may receive signals indicative of other subsidiary accounts, such as accounts with privilege levels to receive invalidated and/or flagged submissions, such as submissions invalidated as described with respect to operation 205 of FIG. 2. In some examples, system 600 may autonomously make submissions available to subsidiary accounts based on those submissions' categories. In other examples, system 600 may make such submissions available to such subsidiary account in response to input via the primary account. For instance, the primary account's submission management interface 622 (discussed below) may include elements to receive signals indicating that a certain submission should be made available to the subsidiary account holder assigned to the submission's category.

As another example, subsidiary account management interface 617 may include elements to make available which submissions have been assigned to which subsidiary accounts. For example, subsidiary account management interface 617 may include a list of assigned submissions for each of the subsidiary accounts. In these examples, subsidiary account management interface 617 may include further metadata related to the assigned submissions, such as evaluation scores given by the subsidiary account holders, view status of the assigned submissions, time passed since a submission was assigned to the subsidiary account holder, responses and/or comments received from the subsidiary account holder, and/or the like.

The example primary account portal 615 may include, for example, a submission management interface 618. In this example, the submission management interface 618 includes a display component 621 that makes submissions available for presentation to the primary account holder. For example, the display component 621 may include code to cause the system 600 to operate as described with respect to operation 206 of FIG. 2, operation 302 of FIG. 3, operation 403 of FIG. 4, and/or operation 512 of FIG. 5. In some examples, the display component 621 may include code to cause a view, such as a list, a dashboard or the like, of submissions to be presented via primary account portal 615 according to the associated scores of the submissions. Various information may be presented in the view. For example, the submission identifier, summary, category, ranking/score, a primary account rating, another user's evaluation of the submission (e.g., in the case of system including an other submitter account submission interface 603), metadata such as pinned status, viewed status, archival status, and/or the like.

In some examples, display component 621 may update the view when new submissions are received and/or when a processing operation is updated and submissions are re-scored. For instance, after the primary account holder evaluates a submission, the remaining submissions may be re-scored by the updated processing operation, and the view refreshed. Accordingly, the view may present a dynamic view of the current associated scores of received submissions in accordance with the primary account holder's valuation of the processing operation parameters. In some examples, the system may include multiple views based on various submission conditions and/or view may be configurable according to various filter conditions, such as category filters, view-status filters, evaluation scores, results of specific processing operations (e.g., based on statistics, semantic and/or temperament evaluation as discussed with respect to operations 506, 508, 509 of FIG. 5), subsidiary account-related status, manually tagged status (e.g. pinned status), and/or the like. For instance, the display component 621 may make a view available that displays submissions requiring or undergoing further actions, such as submissions flagged for follow-up, awaiting a response from the user (e.g., a request to reveal the user's identity), marked as a potential duplicate submission, forwarded to a subsidiary account for action, and/or the like.

In further examples, the view may include identification elements to highlight and/or organize submissions based on associated score. For instance, display component 621 may group and/or emphasize (e.g., highlight) the submissions according to score. In some cases, the grouping may be based on configurable score thresholds. For instance, a first group may include the highest rated X %, the highest rated N cases, cases with at least K points, and/or the like, subsequent groups may be configured using like thresholds. In a particular example, submission are highlighted in green when having at least K points, in yellow when having between K and J points, and in red when having between 0 and J points, where K and J are configurable thresholds.

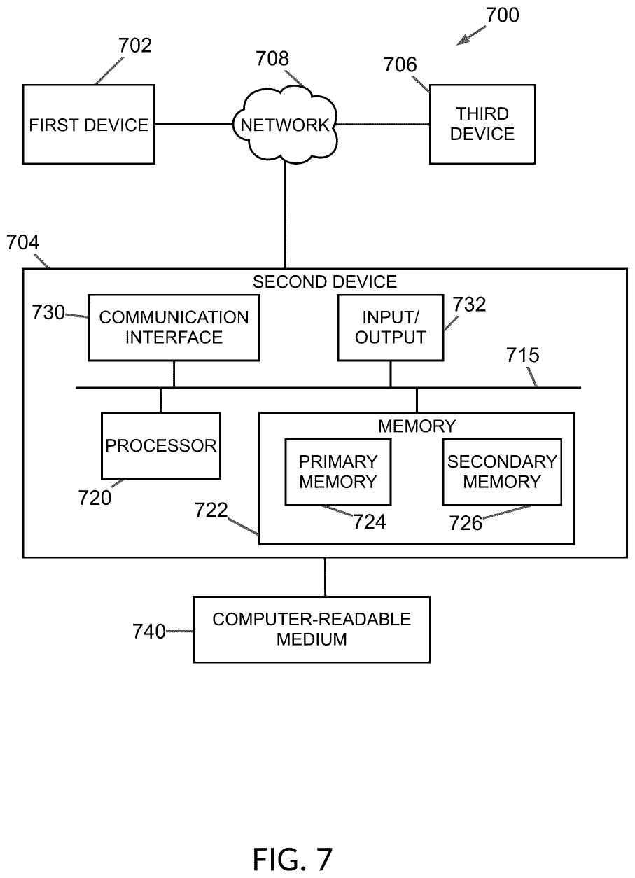

The example submission management interface 618 may include, for example, a submission evaluation interface 619. For instance, submission evaluation interface 619 may include elements to receive signals to operate as described with respect to operation 207 of FIG. 2, operation 303 of FIG. 3, operation 403 of FIG. 4, and/or operation 513 of FIG. 5. In some examples, the display component 621 and the evaluation interface 619 may be provided as a common interface. For example, the display may comprise interactive evaluation elements for the listed submissions. An example of such an interface is provided in FIG. 7. In some examples, the interface 619 may include interactive elements to provide a detailed view of a listed submission. For example, the listed submissions may be displayed with embedded hyperlinks that open a detailed view of the corresponding submission.

Evaluation interface 619 may include elements to receive high level ratings and lower level ratings. For instance, interface 619 may a first level interface displaying a list of submissions as described with respect to display component 621. The first level interface may include web-buttons, drop down menus or the like, to receive a “like” and/or “dislike” rating. In this example, when a submission is rated “like”, system 600 may bring up a second level of interface 619 displaying a detailed view of the submission. Here, the second level of interface 619 makes data available to the primary account device indicative of the submission details. For example, the first level of interface 619 may present the title and summary of submissions, while the second level of interface 619 may present the title, summary, detailed description, responses to customized prompts, and other like fields. The second level of interface 619 may additionally provide interactive elements to receive primary account ratings and/or other actions. For example, the second level of interface 619 may provide drop-down menus, web-buttons, or the like, to receive a rating for the submission. For example, the rating may be as described with respect to operation 513. As a particular example in an enterprise environment, evaluations may be entered via selection from a scale such as: {1: Interest Generated; 2: Looks Promising; 3. Very Stimulating; 4: Impactful; 5: Diving-in Immediately}.

In some examples, a summary view interface 619 and/or detailed view interface 619 may include other like interactive elements. For instance, submissions may be removed from a default view, such as through archival as discussed with operation 512 of FIG. 5. In these examples, interface 619 may include interactive elements such as buttons, drop down menu, and/or the like, to control the archival status. For example, interface 619 may include a link (e.g., via a web-button, text link, drop down menu, or the like) to receive signals indicative of placing the submission into an archived state. As another example, interface 619 may include a view of archived submissions, and may include interactive elements to receive signals indicated of removing the submission from the archived state. In some examples, additional rating scales may be used for disliked or archived submissions. For instance, in an example with a 1-5 rating for non-archived cases, archived or disliked submissions may receive a rating from −1 to −5.

As another example, interface 619 may include elements to receive signals indicative of taking other actions with respect to the submission. For instance, interface 619 may include links (e.g., web buttons, text links, drop down menu, and/or the like) to receive signals indicative of forwarding the case to report an inappropriate submission. System 600 may make the submission available to other delegates in response to such as report, such as a content moderator, legal department, and/or the like.

Example submission management interface 618 may include, for example, an interaction interface 620. For example, interaction interface 620 may be made available in conjunction with evaluation 619 in a common view and/or may be provided in a separate view. In some examples, Interaction interface 620 may include various interactive elements to communicate with the account holder via the submitter account submission management interface 607. For instance, interface 620 may include fields to receive a request that the account reveal their identity, follow up via an out-of-band channel (e.g., email, third-party message system, and/or the like), and/or may include fields to receive free-form comments, questions, requests for further information, and/or the like. In these example, the system 600 may provide such received information via interface 607 and/or provide responses to such free-form text to the primary account's interface 620. Here, if a request for revealing user identity has not been granted, system 600 may provide such interactions between interface 607 and 620 without presenting identifying information to the primary account.

As another example, the interaction interface 620 may include fields communicating with a subsidiary account holder. For instance, to receive an instruction for the submission to be made available to a subsidiary account, as discussed with respect to interface 617. In some such examples, the second level of interface 609 includes interactive elements to communicate with the subsidiary account regarding the submission, such as a chat window, and/or fields to display responses to the submission from the subsidiary accounts. For example, the second level of interface 617 may includes fields displaying a rating from the subsidiary account, free-form comments, requests for follow-up, and/or the like.

Example primary account portal 615 may include, for example, a group-level information interface 622. For instance, group-level information interface 622 may be provided as an aspect of submission management interface 618. For example, interface 622 may make group-level information available as discussed with respect to operation 206 of FIG. 2, operation 302 of FIG. 3, and/or operation 511 of FIG. 5. For example, interface 622 may present submission scoring statistics, and/or information regarding common and/or frequent terms and/or categories. In some examples, interface 622 may present information calculated at the group level. For example, interface 622 may present an overall sentiment score based on various conditions. As a particular example, system 600 may calculate the overall sentiment score based on a percentage of matched keywords from a positive keyword set within submission received over a certain period of time (e.g., the last 30 days). As another example, system 600 may aggregate user evaluation provided via interfaces 603 and 604. For instance, group information interface 622 may make available data regarding the frequency of usage of interfaces 604 (e.g., how often users give other users' submissions ratings), average ratings received via interfaces 603, 604, keywords and/or other processing operation parameters derived from information received via the interfaces, and/or the like. Group-level information interface 622 may present other data, such as historical data tracking any or all of the above-discussed information. As another example, group-level information interface 622 may present information comparing the organization to other organizations. For instance, data from multiple instantiations of system 600 deployed multiple corresponding organizations may be collected to produce a group-level metric to which individual organizations may be compared.

Example on-line collaboration infrastructure 600 may include, for example, a subsidiary account portal 623. As illustrated, subsidiary account portal 623 may include, for example, a submission management interface 624. In some examples, interface 624 may be configured to receive signals and make data available as described with respect to operations 206, 207 of FIG. 2, operation 301-304 of FIG. 3, and/or operations 501, 502, 512, and 513 of FIG. 5. For instance, in the example environment of FIG. 1, subsidiary account portal 623 may be instantiated on a user device 102, 103, 104, 105 via a website or application served by a server 107 111. For example, submission management interface 624 may be implemented as described with respect to submission management 618, but restricted to submissions that have been made available to the particular subsidiary account. In other examples, the subsidiary account portal 623 may include only a subset of such interface. For instance, a group-level information interface might not be present.

In the illustrated example, submission management interface 624 may include, for example, a display component 625. For example, the display component may include to cause the system 600 to operate as described with respect to operation 206 of FIG. 2, operation 302 of FIG. 3, operation 403 of FIG. 4, and/or operation 512 of FIG. 5. In various examples, the display component 265 may be otherwise as described with respect to display component 621 of the primary account portal 615. For instance, the display component 265 may include code to cause a view, such as a list, a dashboard or the like, of submissions selected for subsidiary account review to be presented via subsidiary account portal 624 according to the associated scores of the submissions.

Subsidiary submission management interface 624 may include, for example, an evaluation interface 627. For instance, submission evaluation interface 627 may include elements to receive signals as described with respect to interface 619 and to operate as described with respect to operation 207 of FIG. 2, operation 303 of FIG. 3, operation 403 of FIG. 4, and/or operation 513 of FIG. 5. In other examples, evaluation interface 627 may receive signals rating and/or ranking the submissions to present to the primary account, without subsequent update to the processing operation. In such examples, the evaluation interface 627 may include interactive elements to receive different types of ratings than primary account evaluation valuation interface 619. For instance, evaluation interface 627 may be limited to rating from a smaller scale (e.g., a binary rating scale such as, “like” and “dislike”), and/or may be limited to free-form text evaluation (e.g., a comment describing the primary account's review of the submission).

In some examples, the display component 625 and the evaluation interface 627 may be provided as a common interface. For example, the display may comprise interactive evaluation elements for the listed submissions. In some examples, the interface 627 may include interactive elements to provide a detailed view of a listed submission. For example, the listed submissions may be displayed with embedded hyperlinks that open a detailed view of the corresponding submission. Such a detailed view may be presented as described with respect to evaluation interface 619 and/or may include elements specific to the subsidiary account portal 623. For instance, a subsidiary account evaluation interface 627 may include fields to receive an evaluation of the feasibility of the submission (e.g., if a technical idea is technologically feasible, if an account-related comment conforms to accounting practices, and/or the like).

In some examples, subsidiary account submission management interface 624 includes an interaction interface 626. In some examples, the interaction interface 626 may include fields and/or other interactive elements to communicate with the submitter account corresponding to a submission. For instance, the interaction interface 626 may include such elements as described with respect to interaction interface 620. In other examples, the subsidiary account interaction interface 626 may include a subset of elements of primary account interaction interlace 620. For instance, subsidiary interaction interface 626 may lack elements to request that the user reveal their identity and/or follow-up out-of-band. In some examples, the interaction interface 626 may include fields and/or other interactive elements to communicate with the primary account regarding the submission. For instance, subsidiary account interaction interface 626 may include elements corresponding to those present in primary account interaction interface 620.

Subsidiary submission management interface 624 may include, for example, a group-level information interface. For example, interface 622 may make group-level information available as discussed with respect to operation 206 of FIG. 2, operation 302 of FIG. 3, and/or operation 511 of FIG. 5. In some cases, group-level information presented via interface 622 may be limited compared to the primary account's group-level interface 620. For examples, such group-level information may be based on only submissions available to the subsidiary account, only on submissions falling with the category corresponding to the subsidiary account, only to a limited subset of the metrics available to the primary account, and/or the like. In other cases, the group-level information presented via interface 628 may be the same as primary account group-level interface 620. For instance, system 600 may provide a common group-level information interface to which the primary account and subsidiary accounts are granted access.

Example on-line collaboration infrastructure 600 includes components, such as storage components 608, 609, 610, 611 and processing operation components 612. While illustrated as separate components, one or more of these components may be implemented as combined components. For example, the access identifiers and submitter accounts might be stored in a common database, the processing operation 612 may be implemented as a database-centric software component within a database storing the submissions 610, and scoring parameters 609. Likewise, components illustrated as singular may be implemented in a distributed manner. For instance, processing operation 612 may comprise processing operation software code executed be multiple computers in a distributed system. Of course, as discussed above, in some examples, the illustrated system may be implemented via software components deployed in various architectures, such as web-queue-worker architectures, n-tier application architectures, microservice-based architectures, data-driven architectures, and/or the like. Accordingly, while the description may be made with reference to certain example environments, such as the environment of FIG. 1, or certain example architectures, the scope of the system is not limited to these examples and should be understood to example environments and/or architectures.

Example on-line collaboration infrastructure 600 may include, for example, access identifier storage 608. Access identifier storage 608 may store access identifiers and associated data and/or metadata as described with respect to operation 202 of FIG. 2, operation 401 of FIG. 4, and/or account registration interface 602. As an example, a separate access identifier may be provisioned for each submitter account. In this example, storage 608 may store a mapping between access identifiers and corresponding submitter accounts. Here, storage 608 may further store metadata related to submitter accounts and/or access identifiers. For example, storage 608 may store tags related to the access identifiers, such as whether the access identifier is available for a new registration or has already been used for a submitter account. Here, system 600 may reject an attempted user registration that is unavailable. For example, this may enable users to register using personal registration information while preventing duplicate or fraudulent registrations. As another example, storage 608 may store time-to-live and/or expiration dates for the access identifiers. Here, system 600 may reject an attempted user registration that includes an expired access identifier. As a further example, storage 608 may store metadata comprising organizational status of the submitter account associated with the access identifier. For example, in an enterprise deployment, storage 608 may include information elements indicating whether a user is currently employed at the enterprise. Here, system 600 may discontinue system access to a user whose access identifier is tagged as not a member of the organization. For instance, a primary account holder or delegate may provide signals indicative of current organizational membership (e.g., an employee roster) to system 600. System may validate registered users against the information and update the status tags accordingly. This may enable invalidation of ex-member accounts without confirming the existence of such accounts and/or providing the identity of such accounts to the primary account.

Example on-line collaboration infrastructure 600 may include, for example, scoring parameter storage 609. In some examples, scoring parameter storage 609 may store preconfigured parameters or parameters provided by the primary account holder as described with respect to operation 201 of FIG. 2, operation 301 of FIG. 3, operation 501 of FIG. 5, and/or scoring parameter interface 616. In some examples, scoring parameter storage 609 may store system-computed parameters computed during processing operation initialization. For instance, parameter storage 609 may store parameters computed as described with respect to operation 502 of FIG. 5. In some examples, scoring parameter storage 609 may store system-computed parameters computed during processing operation update. For instance, parameter storage 609 may store parameters computed as described with respect to operation 208 of FIG. 2, operation 304 of FIG. 3, operation 403 of FIG. 4, and/or operation 514. For instance, scoring parameter storage 609 may store keyword sets, keyword values and/or weights, category rankings, keyword statistics for trending keywords, decision tree weights, or the like.

Example on-line collaboration infrastructure 600 may include, for example, submission storage 610. submission storage 610 may store submissions as described with respect to operations 203 and 204 of FIG. 2, operation 302 of FIG. 3, operation 402 of FIG. 2, operation 503 of FIG. 5, and/or submission interface 606. Additional data related to the submissions may also be stored in submission storage 610. For example, submission storage 610 may include evaluation information entered via the primary account submission evaluation interface 619 or via the subsidiary account submission evaluation interface 627. For instance, submission storage 610 may store such evaluation information itself and/or may store links to other storage locations storing such evaluation information. As another example, submissions storage 610 may store data related to processing operation 612. For instance, it may store data related to keyword frequencies within the submission, processing operation scoring of the submission, duplication status and/or other validity-related information, average sentence length, date submitted, length of time to complete the submission, and/or the like.

In some examples, submission storage 610 stores the submissions with submission identifiers. For example, as described with respect to operation 204 of FIG. 2, the submission identifier may be a number or alphanumeric information element that is unique to the particular submission which it identifies. In some examples, the submissions 610 are stored separately from account identity information. For instance, the submissions may be stored in a first database keyed by the submission identifiers while a second database stores mappings from the submission identifiers to the submitter accounts (e.g., the submission identifiers may serve as foreign keys to the submitter account database). In other examples, the submissions 610 are stored in the same location in another manner that prevents identification by the primary account holder. For instance, submission storage 610 may have multiple privilege levels, where the primary account is not granted access privileges to the mapping between submission identifiers and submissions. As another example, system 600 might not surface submitter account information to the primary account or subsidiary accounts via the portals 615, 623 absent user consent.

Example on-line collaboration infrastructure 600 may include, for example, account data storage 611. Account data storage 611 may store submitter account information as described with respect to operation 202 of FIG. 2, operation 401 of FIG. 4, and/or account registration interface 602 of FIG. 6. In further examples, account data storage 611 may store various information related to the account's use, access, history, status, or the like. For example, account data storage 611 may store the account's submissions (e.g., submission identifiers, the submissions themselves, links to the submissions, or the like), the submitter account's use of interfaces 603 and 604, the account user's status within the organization (e.g., a current or ex-employee), and/or the like.

Example on-line collaboration infrastructure 600 may include, for example, submission processing component 612. Submission processing component may include software code stored on a non-transitory medium and configured to cause a computing system to execute processing operations as described with respect to operations 201, 205, and 208 of FIG. 2, operations 301 and 304 of FIG. 3, operation 403 of FIG. 4, and/or operations 502, 504, and 514 of FIG. 5. As an example in the environment of FIG. 1, submission processing component 612 may be executed by a server 107, 111, including in a distributed manner on a plurality of servers 107, 111. In the illustrated example, submission processing component 612 may be connected to scoring parameter storage 609 to receive scoring parameters for processing operation initialization, submission scoring, and/or processing operation update. Submission processing component 612 may be connected to primary account portal 615 to receive initialization and/or update parameters from scoring parameter interface 616, to provide associated scores for display via display component 621, and/or to evaluation interface 619 to receive primary account evaluations for use in processing operation updates. Submission processing component 612 may be connected to submitter account portal 601 to validate new submissions via interface 606, to provide associated scores for display via existing submission interface 607, and/or to provide associated scores and/or receive user evaluations via interface 606. Submission processing component 612 may be connected to subsidiary account portal 623 to provide associated scores for display via display component 625, and/or to evaluation interface 627 to receive primary account evaluations for use in processing operation updates.

Example submission processing component may include, for example, a submission validation component 613. Validation component 613 may comprise software code stored on a non-transitory medium and configured to cause a computing system to operate as described with respect to operation 205 of FIG. 2, and/or operation 505 of FIG. 5. For example, validation component 613 may be connected to submission interface 606 and/or submission storage 610 to conduct duplication analyses and/or detect presence of other invalidating conditions (e.g., those described with respect to operation 205 of FIG. 2). In some such examples, validation component may receive duplicate status overrides from interface Additionally, validation component may be connected to primary account evaluation interface 619 and/or display component 621. For example, validation component may make data available for potential duplicate submissions to be presented via display component 621 and/or to receive duplicate status overrides via evaluation interface 619. For instance, validation component 613 may receive signals indicative that a certain submission is a duplicate and/or that a certain duplicate-marked submission is not a duplicate. In these examples, validation component may update the submission status via the submission storage 610.

Example submission processing component may include, for example, submission scoring component 614. Scoring component 614 may comprise software code stored on a non-transitory medium and configured to cause a computing system to operate as described with respect to operations 201, 205, 206, 208 of FIG. 2, operations 301, 302 304 of FIG. 3, operation 403 of FIG. 4, and/or operations 501, 502, 504 (including, for example, operations 506-511), 512, 514 of FIG. 5. For example, scoring component 614 may include code to execute processing operations such as direct or scaling point assignment operations, statistical classification operations, operations, supervised learning operations such as a random forest or other decision tree-based scoring operations, unsupervised learning operations such as attention-based recurrent neural network operations, ensembles and/or other combinations thereof, and/or the like. various text semantics evaluation operations, such as specificity evaluations, semantic keyword analyses, natural language processing operations, supervised and/or unsupervised learning operations, or the like.

In some examples, scoring component 614 may be connected to submitter account portal 601 to display scoring information via existing submission interface 608, and/or to receive evaluation information regarding other submissions via interface 604. Scoring component 614 may be connected to primary account portal 615 to receive scoring-related parameters via interface 616, display scores of submissions via display component 621, to receive evaluation information via interface 619, and/or to provide group-level information via group level information interface 622. Scoring component 614 may be connected to subsidiary account portal 623 to display scores of submissions via display component 621, to receive evaluation information via interface 627, and/or to provide group-level information via group level information interface 628. As described above, scoring component 614 may be connected to scoring parameter storage 609 to store and/or retrieve scoring processing operation parameters, and/or may be connected to submission storage 610 to retrieve submissions for scoring and/or store submission scores with associated submissions.

In the context of the present disclosure, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal and/or other electrical conductor, that is able to conduct electrical current between two tangible components. Likewise, a tangible connection path may be at least partially affected and/or controlled, such that, as is typical, a tangible connection path may be open and/or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components and/or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit and/or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If, alternatively, reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements and/or identical results, unless otherwise expressly indicated.

It is further noted that the terms “type” and/or “like,” if used, such as with a feature, structure, characteristic, and/or the like, using “optical” and/or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices, one or more server devices and/or one or more peer-to-peer devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device, a client device and/or a peer-to-peer device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present disclosure, the terms map-reduce architecture and/or similar terms are intended to refer to a distributed computing system implementation and/or embodiment for processing and/or for computing larger sets of signal samples employing map and/or reduce operations for a parallel, distributed process performed over a network of devices. A map operation and/or similar terms refer to processing of signals (e.g., signal samples) to compute one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present disclosure, use of the term “Hadoop” is intended to include versions, presently known and/or to be later developed.

In the context of the present disclosure, the term “network device” refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in a non-transitory memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” and/or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present disclosure, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present disclosure, the term “transparent,” if used with respect to particular communicating devices of a network, refers to the devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes. Thus, a network may include the one or more intermediate nodes and/or the one or more intermediate devices of the one or more intermediate nodes in communications and the network may engage in communications via the one or more intermediate nodes and/or the one or more intermediate devices of the one or more intermediate nodes, but the network may operate as if such intermediate nodes and/or intermediate devices are not necessarily involved in communications between the particular communicating devices. For example, a router may provide a link and/or connection between otherwise separate and/or independent LANs.

In the context of the present disclosure, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source and/or designated destination for one or more signal packets and/or signal frames, for example. It is understood in the context of the present disclosure that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present disclosure, may comprise a service that organizes stored digital content, such as, for example, text, images, video, etc., through the use of hypermedia, for example. It is noted that a network, such as the Internet and/or Web, may be employed to store electronic files and/or electronic documents.

The term “electronic file” and/or the term “electronic document” or the like are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present disclosure, the term “Web site” and/or similar terms refer to Web pages that are associated electronically to form a particular collection thereof. Also, in the context of the present disclosure, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

As was indicated, in the context of the present disclosure, the terms “entry,” “electronic entry,” “document,” “electronic document,” “content,”, “digital content,” “item,” “object,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present disclosure, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed and/or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present disclosure, a component is physical, but is not necessarily tangible. As an example, components with reference to an electronic document and/or electronic file, in one or more embodiments, may comprise text, for example, in the form of physical signals and/or physical states (e.g., capable of being physically displayed and/or maintained as a memory state in a tangible memory). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed and/or maintained as a memory state in a tangible memory). In an embodiment, digital content may comprise, for example, text, images, audio, video, haptic content and/or other types of electronic documents and/or electronic files, including portions thereof, for example.

Also, in the context of the present disclosure, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” and/or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this disclosure, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present disclosure, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer and/or in a “pull type” of signal transfer. In the context of the present disclosure, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” and/or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular disclosure, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present disclosure, the term “between” and/or similar terms are understood to include “among” if appropriate for the particular usage and vice-versa. Likewise, in the context of the present disclosure, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, 4^{th}, and/or 5th generation (2G, 3G, 4G, and/or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), IEEE 802.11 (including, but not limited to, IEEE 802.11b/g/n), and/or the like. A wireless network may include virtually any type of now known and/or to be developed wireless communication mechanism and/or wireless communications protocol by which signals may be communicated between devices, between networks, within a network, and/or the like, including the foregoing, of course.

Turning now to FIG. 7, FIG. 7 illustrates an example system 700 embodiment of an network-connected device providing aspects of infrastructure for on-line collaboration and electronic submission evaluation. For example, the illustrated devices and network may be deployed in an example environment such as the example discussed with respect to FIG. 1. In one example embodiment, as shown in FIG. 7, a system embodiment may comprise a local network (e.g., a second device 704 and a computer-readable medium 740) and/or another type of network, such as a computing and/or communications network. For purposes of illustration, therefore, FIG. 7 shows an embodiment 700 of a system that may be employed to implement either type or both types of networks. For example, system 700 may implement one or more components of the system illustrated with respect to FIG. 6. For instance, system 700 may comprise a computing device 704 implementing a user 601, recipient 615, or subsidiary 623 account portal as described above. Here, first device 702 may represent a first device interacting with the submitter account portal 601, while second device 706 may represent a primary account device interacting with the primary account portal 706. Of course, the roles of devices 702, 706, 704 may be interchanged. For instance, the first device 702 or third device 706 may represent a computing device 704 implementing one or more components of the system 600, while the second device 704 may represent a submitter account device or primary account device interacting with the system 600.

Network 708 may comprise one or more network connections, links, processes, services, applications, and/or resources to facilitate and/or support communications, such as an exchange of communication signals, for example, between a computing device, such as 702, and another computing device, such as 706, which may, for example, comprise one or more client computing devices and/or one or more server computing device. By way of example, but not limitation, network 708 may comprise wireless and/or wired communication links, telephone and/or telecommunications systems, Wi-Fi networks, Wi-MAX networks, the Internet, a local area network (LAN), a wide area network (WAN), or any combinations thereof. For example, network 708 may a network as described with respect to networks 109 or 110 of FIG. 1.

Example devices in FIG. 7 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present disclosure at least, this is understood to refer to sufficient structure within the meaning of 35 § USC 15 (f) so that it is specifically intended that 35 § USC 15 (f) not be implicated by use of the term “computing device” and/or similar terms; however, if it is determined, for some reason not immediately apparent, that the foregoing understanding cannot stand and that 35 § USC 15 (f) therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1 and 5 of the present disclosure.

Referring now to FIG. 7, in some embodiments, first and/or third devices 702, 706 may be capable of rendering a graphical user interface (GUI) for a network device and/or a computing device, for example, so that a user-operator may engage in system use. For instance, first and/or third devices 702, 706 may be capable of rendering a submitter account portal 601, a primary account portal 615, or a subsidiary account portal 623, as described with respect to FIG. 6. In other embodiments, first and/or third devices 702, 706 may operate in a “headless” manner without a GUI. For example, the devices illustrated may be user devices such as devices 102, 103, 104, 105, server devices such as servers 107, and/or nodes 111, as discussed with respect to FIG. 1. For instance, first and/or third devices 702, 706 may operate as storage servers to provide storage 608, 609, 610, 611 as described with the respect to FIG. 6. As another example, first and/or third devices 702, 706 may operate as compute servers implementing submission processing component 612. Device 704 may potentially serve a similar function in this illustration. Likewise, in FIG. 7, computing device 702 (‘first device’ in figure) may interface with computing device 704 (′second device′ in figure), which may, for example, also comprise features of a client computing device and/or a server computing device, in an embodiment. Processor (e.g., processing device) 720 and memory 722, which may comprise primary memory 724 and secondary memory 726, may communicate by way of a communication bus 715, for example. The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Computing device 704, as depicted in FIG. 7, is merely one example, and claimed subject matter is not limited in scope to this particular example.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D and/or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable and/or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as IOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of e-mail, short message service (SMS), and/or multimedia message service (MMS), including via a network, such as a social network, formed at least in part by a portion of a computing and/or communications network, including, but not limited to, Facebook, Linkedin, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 7, computing device 702 may provide one or more sources of executable computer instructions in the form physical states and/or signals (e.g., stored in memory states), for example. For example, computing device 702 may perform the processes described with respect to FIGS. 2-5 and/or implement the components described with respect to FIG. 6. For instance, computing device 702 may host one or more components of an on-line collaboration system and/or may interact with such a system. Computing device 702 may communicate with computing device 704 by way of a network connection, such as via network 708, for example. As previously mentioned, a connection, while physical, may not necessarily be tangible.

Although computing device 704 of FIG. 7 shows various tangible, physical components, claimed subject matter is not limited to computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 722 may comprise any non-transitory storage mechanism. Memory 722 may comprise, for example, primary memory 724 and secondary memory 726, additional memory circuits, mechanisms, or combinations thereof may be used. Memory 722 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 722 may be utilized to store a program of executable computer instructions. For example, processor 720 may fetch executable instructions from memory and proceed to execute the fetched instructions. Memory 722 may also comprise a memory controller for accessing device readable-medium 740 that may carry and/or make accessible digital content, which may include code, and/or instructions, for example, executable by processor 720 and/or some other device, such as a controller, as one example, capable of executing computer instructions, for example. Under direction of processor 720, a non-transitory memory, such as memory cells storing physical states (e.g., memory states), comprising, for example, a program of executable computer instructions, may be executed by processor 720 and able to generate signals to be communicated via a network, for example, as previously described. Generated signals may also be stored in memory, also previously suggested. As example, computer-readable medium 704 may store instructions that, responsive to execution by processor 720, cause the processor to perform or control performance of operations described with respect to FIGS. 2-5.

Memory 722 may store electronic files and/or electronic documents, such as relating to one or more users, and may also comprise a device-readable medium that may carry and/or make accessible content, including code and/or instructions, for example, executable by processor 720 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present disclosure, and generally, is considered to be a self-consistent sequence of operations and/or similar signal processing leading to a desired result. In the context of the present disclosure, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular disclosure, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state and/or thing. For example, but without limitation, for some types of memory devices, a change in state may involve an accumulation and/or storage of charge and/or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 7, processor 720 may comprise one or more circuits, such as digital circuits, to perform at least a portion of a computing procedure and/or process. By way of example, but not limitation, processor 720 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 720 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 7 also illustrates device 704 as including a component 732 operable with input/output devices, for example, so that signals and/or states may be appropriately communicated between devices, such as device 704 and an input device and/or device 704 and an output device. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli. For instance, a user may make use of input/output devices to display and interact with various aspects of an infrastructure for on-line collaboration and electronic submission evaluation, such as portals 601, 615, and 623 described with respect to FIG. 6.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
receiving one or more digital signals indicative of a first account on a communications network;
receiving one or more digital signals indicative of at least registration information for a second account, the registration information including an access identifier for the communications network;
receiving digital content indicative of an electronic submission;
storing the electronic submission according to a submission identifier;
applying a processing operation to the electronic submission to compute a submission score;
making available the electronic submission based, at least in part, on the submission score;
receiving one or more digital signals indicative of an evaluation of the electronic submission from the first account; and
updating the processing operation based, at least in part, on the evaluation.

2. The method of claim 1, and further comprising:
receiving one or more digital signals indicative of at least one initial processing parameter; and
implementing the processing operation based, at least in part, on the at least one initial processing parameter.

3. The method of claim 1, and further comprising:
computing a plurality of available access identifiers for the first account, wherein the access identifier comprises the plurality of available access identifiers.

4. The method of claim 3, and further comprising:
removing the access identifier from the plurality of available access identifiers responsive to receiving the registration information.

5. The method of claim 1, and further comprising:
making available a plurality of prior electronic submissions;
receiving one or more digital signals indicative of at least one user evaluation of at least one of the plurality of prior electronic submissions; and
implementing the processing operation based, at least in part, on the at least one user evaluation.

6. The method of claim 1, and further comprising:
receiving one or more digital signals indicative of a response to the electronic submission;
determining the second account associated with the electronic submission via the submission identifier; and
making available the response to the second account.

7. The method of claim 1, and further comprising:
applying the processing operation to determine a prior electronic submission; and
implementing the processing operation based, at least in part, on the determined prior electronic submission.

8. The method of claim 1, and further comprising:
grouping a plurality of electronic submissions based, at least in part, on a plurality of respective submission scores;
applying the processing operation to compute group-level information for the plurality of electronic submissions; and
making available the group-level information to the first account.

9. A non-transitory computer-readable medium having instructions stored thereon that, responsive to execution by a computing system, cause the computing system to:
receive one or more digital signals indicative of a first account;
make available an electronic submission based, at least in part, on a submission score, wherein the electronic submission is associated with a submission identifier;
receive one or more digital signals indicative of an evaluation of the electronic submission; and
initiate an update to a submission scoring processing operation based, at least in part, on the evaluation.

10. The non-transitory computer-readable medium of claim 9, wherein the instructions to further cause the computing system to:
receive one or more digital signals indicative of a response to the electronic submission;
determine a second account associated with the electronic submission via the submission identifier; and
make available the response to the second account.

11. The non-transitory computer-readable medium of claim 9, wherein the instructions to further cause the computing system to:
receive one or more digital signals indicative of at least one initial processing parameter; and
cause the submission scoring processing operation to be implemented based, at least in part, on the at least one initial processing parameter.

12. The non-transitory computer-readable medium of claim 9, wherein the instructions to further cause the computing system to:
receive one or more digital signals indicative of a plurality of candidate accounts, the candidate accounts to include a corresponding plurality of available access identifiers.

13. The non-transitory computer-readable medium of claim 9, wherein the instructions to further cause the computing system to:
make available a plurality of electronic submissions based, at least in part, on a corresponding plurality of submission scores;
responsive to an update of the submission scoring processing operations, make available the plurality of electronic submissions based, at least in part, on a corresponding plurality of updated submission scores.

14. The non-transitory computer-readable medium of claim 13, wherein the instructions to further cause the computing system to:
make available group-level information for groups of the plurality of electronic submissions, the groups to be computed by the submission scoring processing operation based, at least in part, on the submission scores.

15. The non-transitory computer-readable medium of claim 9, wherein the instructions to further cause the computing system to:
receive one or more digital signals indicative of an additional account; and
make available the electronic submission to the additional account.

16. A method, comprising:
receiving one or more digital signals indicative of registration information for a first account, the registration information including an access identifier;
receiving one or more digital signals indicative of an electronic submission;
making available, via a submission identifier, the electronic submission for scoring by a processing operation and/or for evaluation by a second account, the evaluation by the second account to initiate an update to the processing operation.

17. The method of claim 16, and further comprising:
making available a plurality of prior electronic submissions;
receiving one or more digital signals indicative of at least one user evaluation of at least one of the plurality of prior electronic submissions; and
initiating an update to the processing operation based, at least in part, on the at least one user evaluation.

18. The method of claim 16, and further comprising:
receiving one or more digital signals indicative of a response to the electronic submission;
determining the first account associated with the electronic submission based, at least in part, on the submission identifier; and
making available the response to the first account.

19. The method of claim 16, and further comprising:
removing the access identifier from a plurality of available access identifiers responsive to receiving the registration information.

20. The method of claim 16, and further comprising:
applying the processing operation to determine a similar prior electronic submission; and
updating the processing operation based, at least in part, on the determination of the similar prior electronic submission.
